(19) United States
(12) Patent Application Publication
(10) Pub. No.: US 2021/0352522 A1
(43) Pub. Date: Nov. 11, 2021

(54) METHOD AND DEVICE FOR TRANSMITTING AND RECEIVING DATA IN WIRELESS COMMUNICATION SYSTEM

(71) Applicant: Samsung Electronics Co., Ltd., Suwon-si, Gyeonggi-do (KR)

(72) Inventors: June HWANG, Suwon-si (KR); Beomsik BAE, Suwon-si (KR)

(21) Appl. No.: 17/277,537

(22) PCT Filed: Sep. 18, 2019
(86) PCT No.: PCT/KR2019/012100

§ 371 Date: Mar. 18, 2021

(30) Foreign Application Priority Data
Sep. 18, 2018 (KR) 10-2018-0111752

(51) Int. Cl. H04W 28/02

(52) U.S. Cl. CPC H04W 28/0278

(57) ABSTRACT

Provided is an integrated access and backhaul (IAB) node in a wireless communication system for receiving downlink (DL) flow control configuration information, reporting DL flow control feedback information to an IAB parent node, based on at least one of a format of the DL flow control feedback information, report granularity of the DL flow control feedback information, a data quantity of the DL flow control feedback information, a data type of the DL flow control feedback information, or a report condition of the DL flow control feedback information determined from the received DL flow control configuration information, and receiving, from the IAB parent node, data scheduled based on the DL flow feedback information.

### TECHNICAL FIELD

The disclosure relates to a method and apparatus for transmitting or receiving data in a wireless communication system.

### BACKGROUND ART

To meet the increasing demand with respect to wireless data traffic since the commercialization of the 4G communication system, there have been efforts to develop an advanced 5th generation (5G) system or pre-5G communication system. For this reason, the 5G or pre-5G communication system is also called a beyond 4th-generation (4G) network communication system or post long term evolution (LTE) system. Implementation of the 5G communication system using ultra-frequency (mmWave) bands, e.g., 60 giga hertz (GHz) bands, is considered to attain higher data rates. To reduce propagation loss of radio waves and increase a transmission range of radio waves in the ultra-frequency bands, beamforming, massive multiple-input multiple-output (MIMO), Full Dimensional MIMO (FD-MIMO), array antenna, analog beamforming, and large-scale antenna techniques are under discussion. To improve system networks, technologies for advanced small cells, cloud radio access networks (RANs), ultra-dense networks, device to device (D2D) communication, wireless backhaul, moving networks, cooperative communication, coordinated multi-points (CoMP), reception-end interference cancellation and the like are also being developed in the 5G communication system. In addition, in the 5G system, advanced coding modulation (ACM), e.g., hybrid FSK and QAM modulation (FQAM), sliding window superposition coding (SWSC), and advanced access technology, e.g., filter bank multi carrier (FBMC), non-orthogonal multiple access (NOMA), sparse code multiple access (SCMA), are being developed.

In the meantime, the Internet is evolving from a human-oriented connectivity network where humans generate and consume information to an Internet of things (IoT) network where distributed entities or things send, receive and process information without human intervention. Internet of Everything (IoE) technologies, in which big data processing technology through connection with a cloud server, for example, is combined with IoT technology, have also emerged. To implement IoT, various technology elements, such as a sensing technology, a wired/wireless communication and network infrastructure, service interfacing technology, and security technology are required, and recently, even technologies for a sensor network, machine to machine (M2M) communication, and machine type communication (MTC) for connection between things are being studied. In the IoT environment, intelligent Internet Technology (IT) services that create new value for human life by collecting and analyzing data generated from connected things may be provided. IoT may be applied to a variety of areas, such as smart homes, smart buildings, smart cities, smart cars or connected cars, a smart grid, health care, smart home appliances and advanced medical services through convergence and combination between existing information technologies (IT) and various industrial applications.

In this regard, various attempts to apply the 5G communication system to the IoT network are being made. For example, technologies regarding sensor networks, M2M communication, MTC, etc., are implemented by the 5G communication technologies, such as beamforming, MIMO, array antenna schemes, etc. Even application of a cloud radio access network (cloud RAN) as the aforementioned big data processing technology may be considered as an example of convergence of 5G and IoT technologies.

With the development of the aforementioned technologies and mobile communication systems, it is possible to provide various services, and a method of effectively providing the services is required.

### DESCRIPTION OF EMBODIMENTS

### Technical Problem

Embodiments of the disclosure provide an apparatus and method for effectively providing services in a mobile communication system.

### Solution to Problem

According to an embodiment, a method of transmitting or receiving data at an integrated access and backhaul (IAB) node in a wireless communication system includes receiving downlink (DL) flow control configuration information; performing report of DL flow control feedback information to an IAB parent node, based on at least one of a format of the DL flow control feedback information, report granularity of the DL flow control feedback information, a data quantity of the DL flow control feedback information, a data type of the DL flow control feedback information, or a report condition of the DL flow control feedback information determined from the received DL flow control configuration information; and receiving, from the IAB parent node, data scheduled based on the DL flow control feedback information.

The DL flow control feedback information may include information about at least one of a size of a DL buffer storing data, an available DL buffer size, or a data type for each report granularity of the DL flow control feedback information.

The DL flow control feedback information may include a field of user equipment (UE) identity (ID), which is report granularity of the DL flow control feedback information, and a field of DL buffer size available for each UE.

The report granularity of the DL flow control feedback information may include at least one of a backhaul radio link control (BH RLC) channel, a BH RLC channel group, a logical channel, a logical channel group, a UE, a UE data radio bearer (DRB), or a UE DRB group.

The method may further include receiving a signal to trigger the report of the DL flow control feedback information, and the performing of the report of the DL flow control feedback information may include performing report of the DL flow control feedback information, in response to the receiving of the signal to trigger.

The performing of the report of the DL flow control feedback information may include performing the report of the DL flow control feedback information when an amount of data stored in the DL buffer or a data quantity of a type set to report the DL flow control feedback information meets the report condition of the DL flow control feedback information.

The performing of the report of the DL flow control feedback information may include performing report of the DL flow control feedback information according to preset transmission periodicity or transmission time.

The DL flow control configuration information and the DL flow control feedback information may be provided through a media access control (MAC) layer or backhaul adaptation protocol (BAP) layer.

According to an embodiment, an integrated access and backhaul (IAB) node for transmitting or receiving data in a wireless communication includes a transceiver; and a processor coupled to the transceiver, wherein the processor is configured to control the transceiver to receive downlink (DL) flow control configuration information, perform report of DL flow control feedback information to an IAB parent node, based on at least one of a format of the DL flow control feedback information, report granularity of the DL flow control feedback information, a data quantity of the DL flow control feedback information, a data type of the DL flow control feedback information, or a report condition of the DL flow control feedback information determined from the received DL flow control configuration information, and control the transceiver to receive, from the IAB parent node, data scheduled based on the DL flow control feedback information.

### Advantageous Effects of Disclosure

Embodiments of the disclosure provide an apparatus and method capable of effectively providing a service in a mobile communication system.

With the aforementioned disclosure, a cause of a failure of connection tried by a UE may be more accurately analyzed and a resultant measure may be more accurately taken by a BS.

With the disclosure, a buffer in an IAB node may be kept at a suitable level, thereby solving a buffer overflow or underflow problem.

### BRIEF DESCRIPTION OF THE DRAWINGS

FIG. 1A shows a structure of a long term evolution (LTE) system, according to some embodiments of the disclosure.

FIG. 1B shows a radio protocol architecture of an LTE system, according to some embodiments of the disclosure.

FIG. 1C shows a structure of a next generation mobile communication system, according to some embodiments of the disclosure.

FIG. 1D shows a radio protocol architecture of a next generation mobile communication system, according to some embodiments of the disclosure.

FIG. 1E is a block diagram illustrating an internal structure of a user equipment (UE), according to some embodiments of the disclosure.

FIG. 1F is a block diagram illustrating a structure of a new radio (NR) base station (BS), according to some embodiments of the disclosure.

FIG. 1G is a flowchart illustrating an occasion of receiving IAB UE configuration information transmitted by a BS as one of conditions in which downlink (DL) buffer status report (BSR) or uplink (UL) BSR may be operated, according to some embodiments of the disclosure.

FIG. 1H is a flowchart illustrating an occasion when a UE transmits information regarding an IAB capability as one of conditions in which DL BSR or UL BSR may be operated, according to some embodiments of the disclosure.

FIG. 1I illustrates a case with a DL/UL logical channel group for report granularity and desired buffer size for a data quantity as a type of DL BSR or UL BSR format mode, according to some embodiments of the disclosure.

FIG. 1J illustrates a case with a DL/UL logical channel for report granularity and desired buffer size for a data quantity as another type of DL/UL BSR format mode, according to some embodiments of the disclosure.

FIG. 1K illustrates a case with a DL/UL BH RLC channel (or DL/UL BH RLC channel group) for report granularity and desired buffer size for a data quantity as another type of DL/UL BSR format mode, according to some embodiments of the disclosure.

FIG. 1L illustrates a case with a DL/UL UE DRB (or DL/UL UE DRB group) for report granularity and desired buffer size for a data quantity as another type of DL/UL BSR format mode, according to some embodiments of the disclosure.

FIG. 1M illustrates a case with report granularity generally called an RG and a buffer status for a data quantity as another type of DL/UL BSR format mode, according to some embodiments of the disclosure.

FIG. 1N illustrates a case with report granularity generally called an RG and desired data rates for a data quantity as another type of DL/UL BSR format mode, according to some embodiments of the disclosure.

FIG. 1O is a diagram of a procedure in which a BS directly triggers a UE with a DL/UL BSR request MAC CE in a DL/UL BSR triggering operation, according to some embodiments of the disclosure.

FIG. 1P is a diagram of a procedure in which a BS operates DL/UL BSR by transmitting a condition without a DL/UL BSR request MAC CE in a DL/UL BSR triggering operation, according to some embodiments of the disclosure.

FIG. 1Q is a diagram of a procedure in which a mobile terminal (MT) transmits to a parent IAB node flow control feedback information as a control signal of a BAP layer, according to some embodiments of the disclosure.

FIG. 1R is a diagram of a procedure in which a parent IAB node transmits to an IAB node a granularity index and a threshold for feedback triggering through a signal layer, according to some embodiments of the disclosure.

FIG. 1S is a diagram of a procedure in which, once a parent IAB node transmits periodicity information, an IAB node having received the information transmits feedback information to the parent IAB node at a given periodicity, according to some embodiments of the disclosure.

FIG. 1T is a diagram of a procedure of reporting flow control feedback in a direct report command of a higher node, according to some embodiments of the disclosure.

FIG. 2A shows an example of a structure of a BS with separated functions in a next generation mobile communication system.

FIG. 2B shows an example of a structure of a mobile communication system that supports a split bearer to perform transmission using two radios at a time. (1) of FIG. 2B is an example of a EUTRA-NR Dual Connectivity (EN-DC) structure using an EPC and (2) is an example of a structure to support NR-NR Dual Connectivity in a single BS using a 5GC.

FIG. 2C is a diagram for describing a procedure in which a CU-CP of an SgNB in an EN-DC structure determines QoS parameters for each of MCG and SCG and supports a split GBR bearer, according to some embodiments of the disclosure.

FIG. 2D is a sequence diagram of an operation of a CU-CP of an SgNB in an EN-DC structure when the CU-CP of the SgNB determines QoS parameters for each of MCG and SCG and supports a split GBR bearer, according to some embodiments of the disclosure.

FIG. 2E is a sequence diagram of an operation of a CU-UP of an SgNB in an EN-DC structure when a CU-CP of the SgNB determines QoS parameters for each of MCG and SCG and supports a split GBR bearer, according to some embodiments of the disclosure.

FIG. 2F is a diagram for describing a procedure in which a CU-UP of an SgNB in an EN-DC structure determines QoS parameters for each of MCG and SCG and supports a split GBR bearer, according to some embodiments of the disclosure.

FIG. 2G is a sequence diagram of an operation of a CU-CP of a SgNB in an EN-DC structure when a CU-UP of the SgNB determines QoS parameters for each of MCG and SCG and supports a split GBR bearer, according to some embodiments of the disclosure.

FIG. 2H is a sequence diagram of an operation of a CU-UP of a SgNB in an EN-DC structure when the CU-CP of the SgNB determines QoS parameters for each of MCG and SCG and supports a split GBR bearer, according to some embodiments of the disclosure.

FIG. 2I is a diagram for describing a procedure in which a DU of an SgNB in an EN-DC structure determines QoS parameters for each of MCG and SCG and supports a split GBR bearer, according to some embodiments of the disclosure.

FIG. 2J is a sequence diagram of an operation of a CU-CP of an SgNB in an EN-DC structure when a DU of the SgNB determines QoS parameters for each of MCG and SCG and supports a split GBR bearer, according to some embodiments of the disclosure.

FIG. 2K is a sequence diagram of an operation of a CU-UP of a SgNB in an EN-DC structure when a DU of the SgNB determines QoS parameters for each of MCG and SCG and supports a split GBR bearer, according to some embodiments of the disclosure.

FIG. 2L is a diagram for describing a procedure in which a CU-CP of a gNB in a CU of the gNB in a structure that supports NR-NR DC determines QoS parameters for each of MCG and SCG and supports a split GBR bearer, according to some embodiments of the disclosure.

FIG. 2M is a sequence diagram of an operation of a CU-CP of a gNB in a CU of the gNB in a structure that supports NR-NR DC when the CU-CP of the gNB determines QoS parameters for each of MCG and SCG and supports a split GBR bearer, according to some embodiments of the disclosure.

FIG. 2N is a sequence diagram of an operation of a CU-UP of a gNB in a CU of the gNB in a structure that supports NR-NR DC when the CU-CP of the gNB determines QoS parameters for each of MCG and SCG and supports a split GBR bearer, according to some embodiments of the disclosure.

FIG. 2O shows an example of an information element configuration required to deliver QoS parameter information to be supported for each link leg (e.g., for each of MCG and SCG) in a message delivered to a CU-UP from a CU-CP or to the CU-CP from the CU-UP of an SgNB or gNB, according to some embodiments of the disclosure.

FIG. 2P is a block diagram illustrating a structure of a UE, according to some embodiments of the disclosure.

FIG. 2Q is a block diagram illustrating a structure of a BS, according to some embodiments of the disclosure.

### BEST MODE

According to an embodiment, a method of transmitting or receiving data at an integrated access and backhaul (IAB) node in a wireless communication system includes receiving downlink (DL) flow control configuration information; reporting DL flow control feedback information to an IAB parent node, based on at least one of a format of the DL flow control feedback information, report granularity of the DL flow control feedback information, a data quantity of the DL flow control feedback information, a data type of the DL flow control feedback information, or a report condition of the DL flow control feedback information determined from the received DL flow control configuration information; and receiving, from the IAB parent node, data scheduled based on the DL flow control feedback information.

The DL flow control feedback information may include information about at least one of: a size of a DL buffer storing data, an available DL buffer size, or a data type for each report granularity of the DL flow control feedback information.

The DL flow control feedback information may include a field of user equipment (UE) identity (ID), which is report granularity of the DL flow control feedback information, and a field of DL buffer size available for each UE.

The report granularity of the DL flow control feedback information may include at least one of a backhaul radio link control (BH RLC) channel, a BH RLC channel group, a logical channel, a logical channel group, a UE, a UE data radio bearer (DRB), or a UE DRB group.

The method may further include receiving a signal to trigger the report of the DL flow control feedback information, and the reporting the report of the DL flow control feedback information may include reporting the DL flow control feedback information, in response to the receiving of the signal to trigger.

The reporting of the DL flow control feedback information may include reporting the DL flow control feedback information when an amount of data stored in the DL buffer or a data quantity of a type set to report the DL flow control feedback information satisfies the report condition of the DL flow control feedback information.

The reporting of the DL flow control feedback information may include reporting the DL flow control feedback information according to a preset transmission periodicity or a transmission time.

The DL flow control configuration information and the DL flow control feedback information may be provided through a media access control (MAC) layer or a backhaul adaptation protocol (BAP) layer.

According to an embodiment, an integrated access and backhaul (IAB) node for transmitting or receiving data in a wireless communication includes a transceiver; and a processor coupled to the transceiver, wherein the processor is configured to control the transceiver to receive downlink (DL) flow control configuration information, report DL flow control feedback information to an IAB parent node, based on at least one of a format of the DL flow control feedback information, report granularity of the DL flow control feedback information, a data quantity of the DL flow control feedback information, a data type of the DL flow control feedback information, or a report condition of the DL flow control feedback information determined from the received DL flow control configuration information, and control the transceiver to receive, from the IAB parent node, data scheduled based on the DL flow control feedback information.

### Mode of Disclosure

Operating principles of embodiments of the disclosure will now be described with reference to accompanying drawings. Descriptions of some well-known technologies that possibly obscure the disclosure will be omitted, if necessary. Further, terms, as will be mentioned later, are defined by taking functionalities in the disclosure into account, but may vary depending on practices or intentions of users or operators. Accordingly, the terms should be defined based on the descriptions throughout this specification.

Herein, the terms to identify access nodes, the terms to refer to network entities, the terms to refer to messages, the terms to refer to interfaces among network entities, the terms to refer to various types of identification information, etc., are examples for convenience of explanation. Accordingly, the disclosure is not limited to the terms as herein used, and may use different terms to refer to the items having the same meaning in a technological sense.

Some of the terms and names defined by the 3rd generation partnership project long term evolution (3GPP LTE) will be used hereinafter. The disclosure is not, however, limited to the terms and definitions, and may equally apply to any systems that conform to other standards.

Advantages and features of the disclosure, and methods for attaining them will be understood more clearly with reference to the following embodiments of the disclosure, which will be described in detail later along with the accompanying drawings. The embodiments of the disclosure may, however, be embodied in many different forms and should not be construed as limited to the embodiments set forth herein; rather, these embodiments of the disclosure are provided so that this disclosure will be thorough and complete, and will fully convey the scope of the embodiments of the disclosure to those of ordinary skill in the art. Like numbers refer to like elements throughout the specification.

It will be understood that each blocks and combination of the blocks of a flowchart may be performed by computer program instructions. The computer program instructions may be loaded on a processor of a universal computer, a special-purpose computer, or other programmable data processing equipment, and thus they generate means for performing functions described in the block(s) of the flowcharts when executed by the processor of the computer or other programmable data processing equipment. The computer program instructions may also be stored in computer-usable or computer-readable memories oriented for computers or other programmable data processing equipment, so it is possible to manufacture a product that contains instruction means for performing functions described in the block(s) of the flowchart. The computer program instructions may also be loaded on computers or programmable data processing equipment, so it is possible for the instructions to generate a process executed by the computer or the other programmable data processing equipment to provide steps for performing functions described in the block(s) of the flowchart.

Furthermore, each block may represent a part of a module, segment, or code including one or more executable instructions to perform particular logic function(s). It is noted that the functions described in the blocks may occur out of order in some alternative embodiments. For example, two successive blocks may be performed substantially at the same time or in reverse order depending on the corresponding functions.

The term “module” (or sometimes “unit”) as used herein refers to a software or hardware component, such as field programmable gate array (FPGA) or application specific integrated circuit (ASIC), which performs some functions. However, the module is not limited to software or hardware. The module may be configured to be stored in an addressable storage medium, or to execute one or more processors. For example, the modules may include components, such as software components, object-oriented software components, class components and task components, processes, functions, attributes, procedures, subroutines, segments of program codes, drivers, firmware, microcodes, circuits, data, databases, data structures, tables, arrays, and variables. Functions served by components and modules may be combined into a less number of components and modules, or further divided into a more number of components and modules. Moreover, the components and modules may be implemented to execute one or more central processing units (CPUs) in a device or security multimedia card. In embodiments, the module may include one or more processors.

Descriptions of some well-known technologies that possibly obscure the disclosure will be omitted, if necessary. Embodiments of the disclosure will now be described with reference to accompanying drawings.

Herein, the terms to identify access nodes, the terms to refer to network entities, the terms to refer to messages, the terms to refer to interfaces among network entities, the terms to refer to various types of identification information, etc., are examples for convenience of explanation. Accordingly, the disclosure is not limited to the terms as herein used, and may use different terms to refer to the items having the same meaning in a technological sense. For example, a terminal as herein used may refer to an MAC entity in a terminal present in each of a master cell group (MCG) and a secondary cell group (SCG).

Some of the terms and names defined by the 3rd generation partnership project (3GPP) long term evolution (LTE) will be used hereinafter. The disclosure is not, however, limited to the terms and definitions, and may equally apply to any systems that conform to other standards.

In the following description, a base station is an entity for performing resource allocation for a terminal, and may be at least one of a gNB, an eNB, a Node B, a base station (BS), a radio access unit, a base station controller, or a network node. The terminal may include a user equipment (UE), a mobile station (MS), a cellular phone, a smart phone, a computer, or a multimedia system capable of performing a communication function. It is, of course, not limited thereto.

Especially, the disclosure may be applied to the 3GPP new radio (NR) (which is the 5G mobile communication standard). The disclosure may be applied to intelligent services based on the 5G communication and IoT related technologies, e.g., smart home, smart building, smart city, smart car, connected car, health care, digital education, smart retail, security and safety services. In the disclosure, eNB may be interchangeably used with gNB. For example, a base station referred to as an eNB may also indicate a gNB. Furthermore, the term ‘terminal’ or ‘user equipment (UE)’ may refer not only to a cell phone, an NB-IoT device, and a sensor but also to other wireless communication devices.

Wireless communication systems are evolving from early systems that provide voice-oriented services to broadband wireless communication systems that provide high data rate and high quality packet data services such as 3GPP high speed packet access (HSPA), long term evolution (LTE) or evolved universal terrestrial radio access (E-UTRA), LTE-advanced (LTE-A), LTE-Pro, 3GPP2 high rate packet data (HRPD), ultra mobile broadband (UMB), and IEEE 802.16e communication standards.

As a representative example of such a broadband wireless communication system, an LTE system adopts orthogonal frequency division multiplexing (OFDM) for downlink (DL) and single carrier frequency division multiple access (SC-FDMA) for uplink (UL). The UL refers to a radio link for a UE or MS to transmit data or a control signal to an eNode B or BS, and the DL refers to a radio link for a BS to transmit data or a control signal to a UE or MS. Such a multiple access scheme allocates and operates time-frequency resources for carrying data or control information for respective users not to overlap each other, i.e., to maintain orthogonality, thereby differentiating each user's data or control information.

As a future communication system since the LTE, the 5G communication system needs to freely reflect various demands from users and service providers and thus support services that simultaneously meet the various demands. The services considered for the 5G communication system may include enhanced Mobile Broadband (eMBB), massive Machine Type Communication (mMTC), Ultra Reliability Low Latency Communication (URLL), etc.

In some embodiments, the eMBB is aimed at providing more enhanced data rates than the LTE, LTE-A or LTE-Pro may support. For example, in the 5G communication system, the eMBB is required to provide 20 Gbps peak data rate in DL and 10 Gbps peak data rate in UL in terms of a single BS. Furthermore, the 5G communication system may need to provide increasing user perceived data rate while providing the peak data rate. To satisfy these requirements, enhancement of various technologies for transmission or reception including multiple-input multiple-output (MIMO) transmission technologies may be required in the 5G communication system. While the present LTE uses up to 20 MHz transmission bandwidth in the 2 GHz band for signal transmission, the 5G communication system may use frequency bandwidth wider than 20 MHz in the 3 to 6 GHz band or in the 6 GHz or higher band, thereby satisfying the data rate required by the 5G communication system.

At the same time, in the 5G communication system, mMTC is considered to support an application service such as an Internet of Things (IoT) application service. In order for the mMTC to provide the IoT efficiently, support for access from massive number of terminals in a cell, enhanced coverage of the terminal, extended battery time, reduction in terminal price, etc., may be required. Because the IoT is equipped in various sensors and devices to provide communication functions, it may be supposed to support a large number of terminals in a cell (e.g., 1,000,000 terminals/km²). Furthermore, a terminal supporting the mMTC is more likely to be located in a shadow area, such as underground of a building, which might not be covered by a cell by the nature of the service, so the mMTC may require an even larger coverage than expected for other services provided by the 5G communication system. A terminal supporting the mMTC needs to be a low-cost terminal, and may require quite long battery life time such as 10 to 15 years because the battery in the terminal is hard to be changed frequently.

Finally, the URLLC may be a mission-critical cellular based wireless communication service, which may be used for services used for remote control over robots or machinery, industrial automation, unmanned aerial vehicle, remote health care, emergency alert, etc. Accordingly, communication offered by the URLLC may require very low latency (ultra low latency) and very high reliability. For example, URLCC services may need to satisfy sub-millisecond (less than 0.5 millisecond) air interface latency and simultaneously require error rates lower than 1 packet loss in 10⁻⁵ packets. Hence, for the URLLC services, the 5G system needs to provide a smaller transmit time interval (TTI) than for other services, and simultaneously requires a design that allocates a wide range of resources for a frequency band to secure reliability of the communication link.

Those three services considered in the aforementioned 5G communication system, i.e., eMBB, URLLC, and mMTC, may be multiplexed and transmitted from a single system. In this case, to meet different requirements for the three services, different transmission or reception schemes and parameters may be used between the services. The mMTC, URLLC, and eMBB are examples of different types of services, and embodiments of the disclosure are not limited to the service types.

Although the following embodiments of the disclosure will now be focused on an LTE, LTE-A, LTE Pro or 5G (or NR, next generation mobile communication) system for example, they may be equally applied to other communication systems with similar technical backgrounds or channel types. Furthermore, embodiments of the disclosure will also be applied to other communication systems with some modifications to such an extent that does not significantly deviate from the scope of the disclosure when judged by those of ordinary skill in the art.

In the disclosure, integrated access and backhaul (IAB) is a technical concept of a node serving as a mobile terminal (MT) for a higher IAB node and as a kind of relay node that serves as a base station (BS) for a lower IAB node, where the node serves to gather uplink (UL) traffic coming from a lower IAB node and UL traffic of a normal UE connected to the node itself and deliver the traffic gathered to a higher IAB node, or forward downlink (DL) traffic from a core network to a lower IAB node or a normal UE connected to the node itself. In other words, the IAB refers to a node with access and backhaul communication operations combined by the node performing operation of communicating with a higher IAB node and operation of communicating with a lower IAB node, and a topology system including the node. A node directly connected to a core network is defined as an IAB donor, which does not have a higher IAB node and is connected to the core network by using an IP address system.

When communications are made between a core network and UEs in a multi-hop topology of IAB nodes, radio resource operation of each IAB node is mostly associated with an independent scheduling operation of the IAB node, so DL and UL buffers owned by the IAB node may overflow or remain at a low level depending on radio resource status of each IAB node, the number of UEs currently connected to the IAB node, and an amount of UL/DL traffic given by the higher/lower IAB nodes. A buffer overflowing situation in particular causes the IAB node to discard data packets that it has already had, leading to a data loss, which becomes a serious problem that may occur in the entire IAB operation. A method of reporting, by a UE, a buffer status report (BSR) required to prevent a buffer overflow at each hop in a multi-hop system of IAB nodes will now be described.

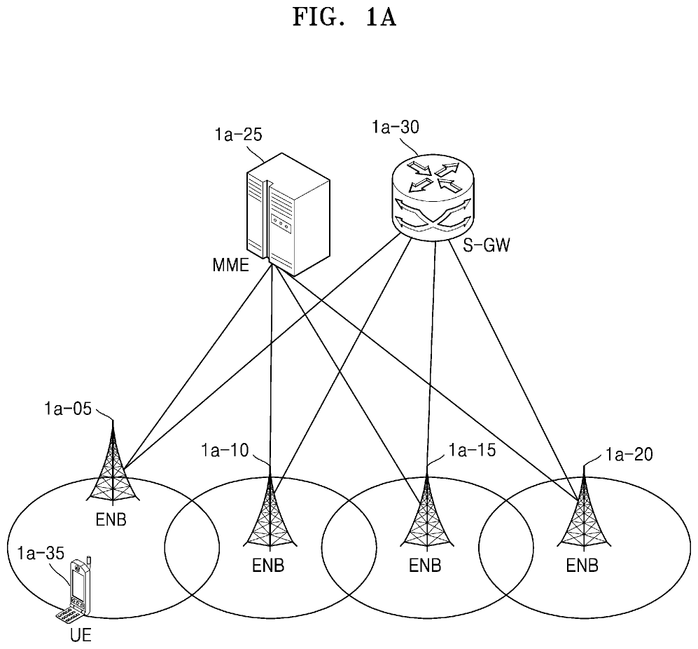

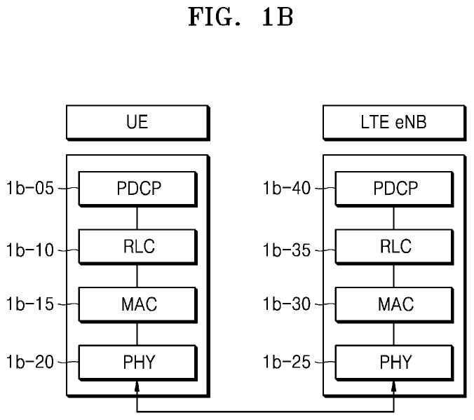

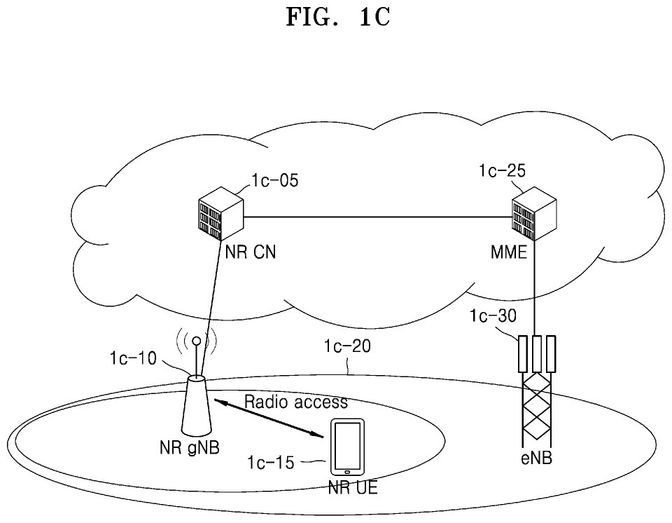

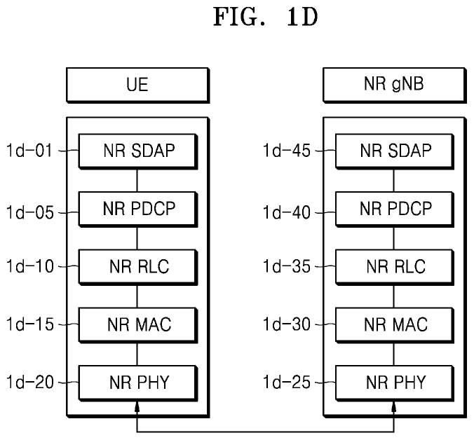

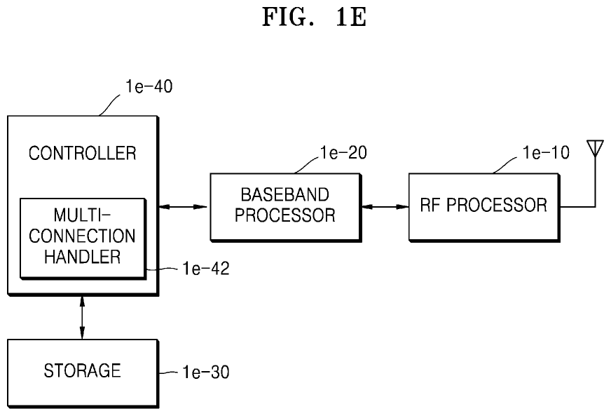

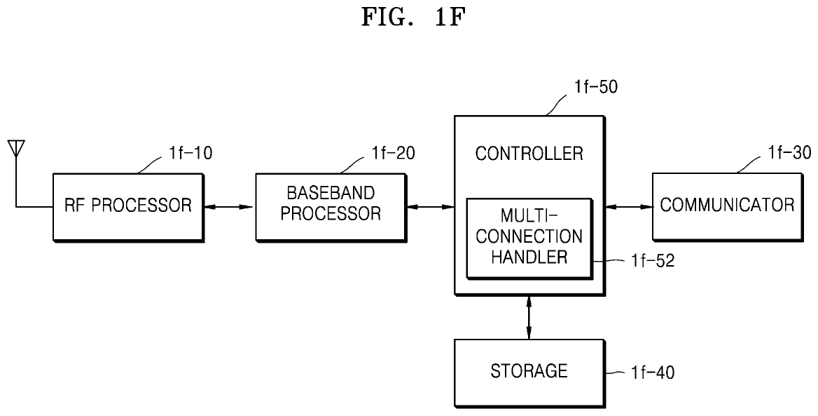

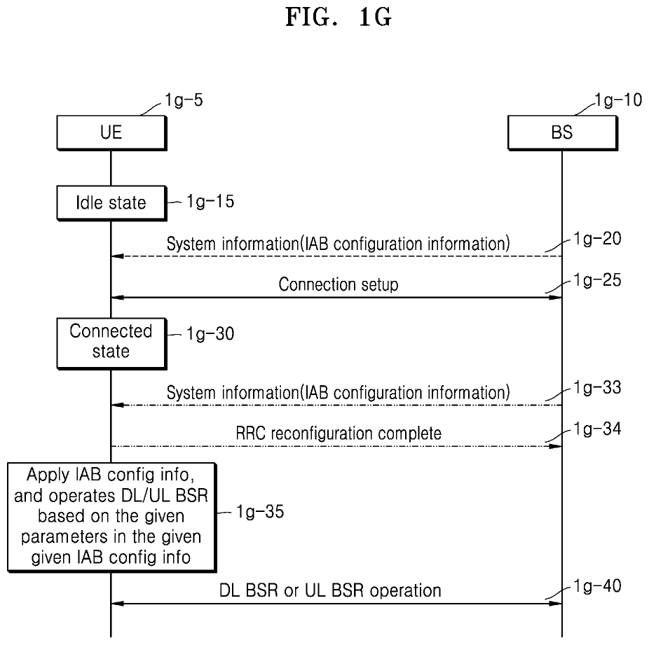

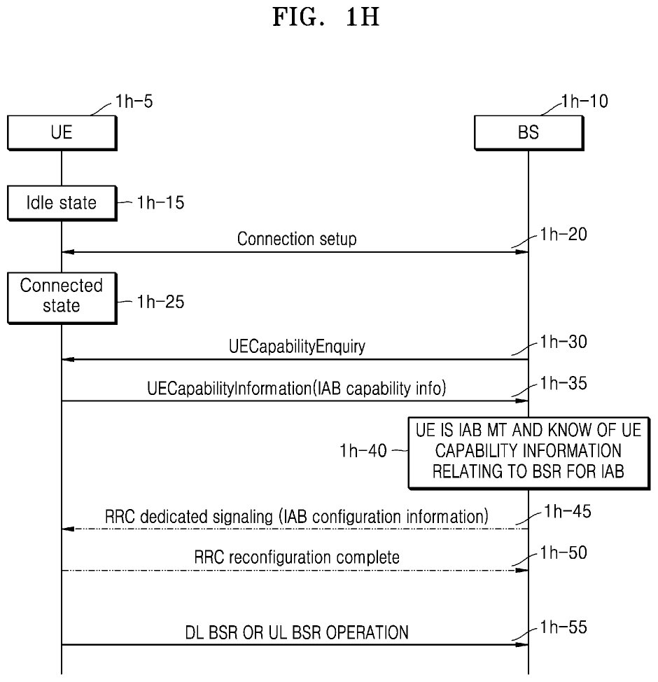

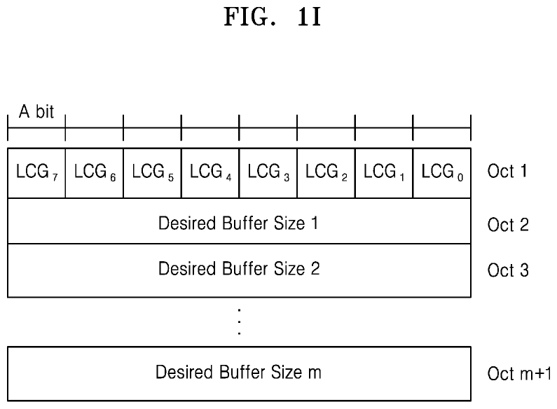

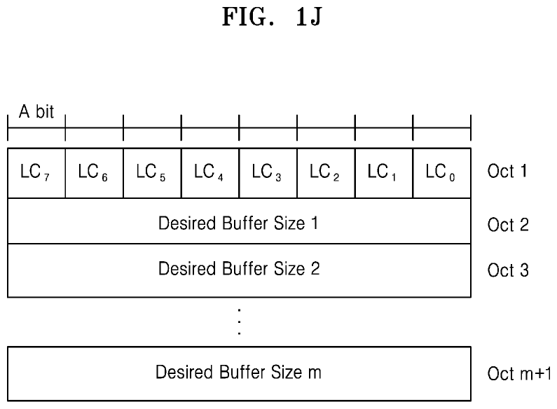

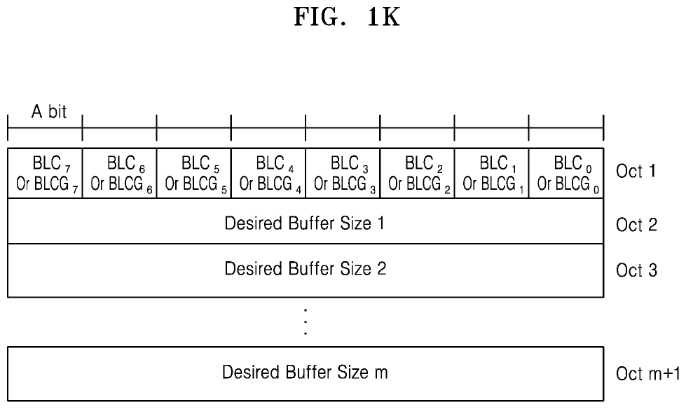

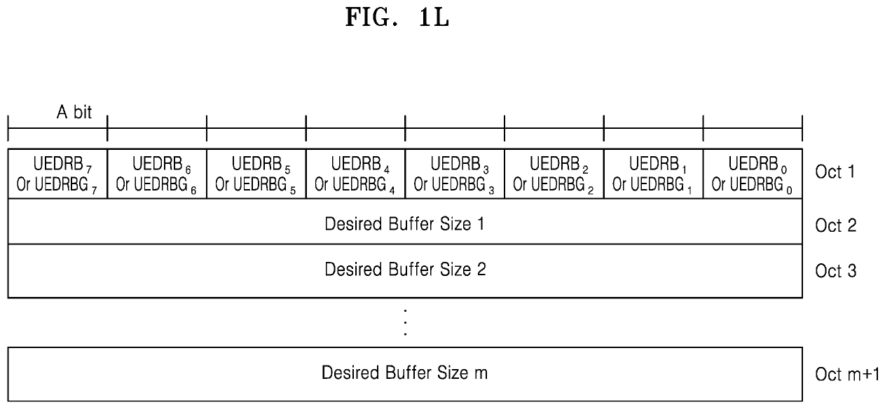

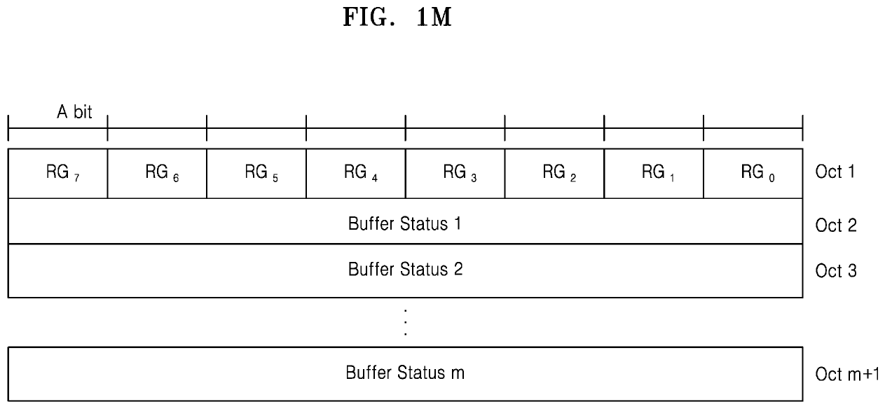

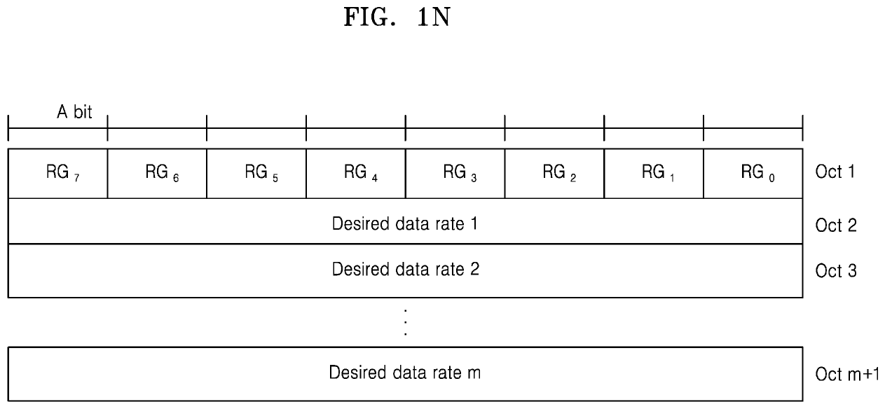

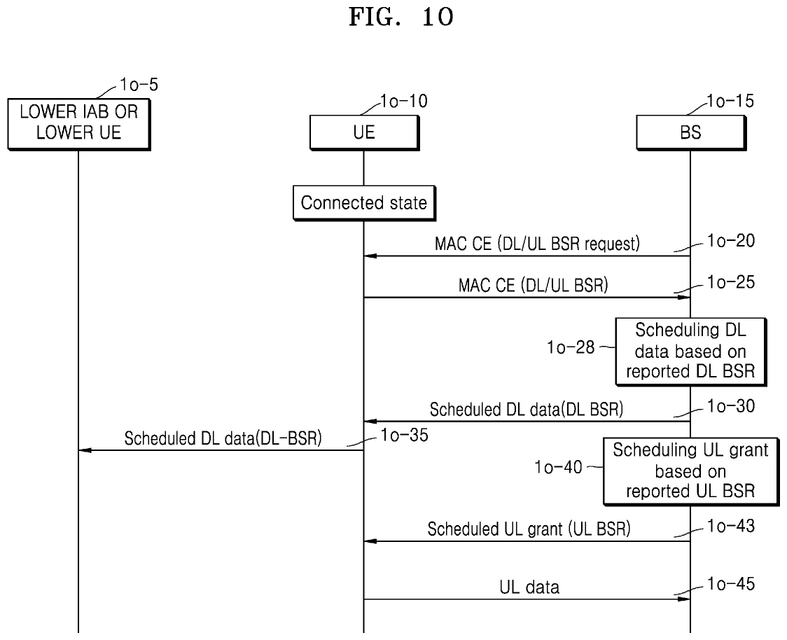

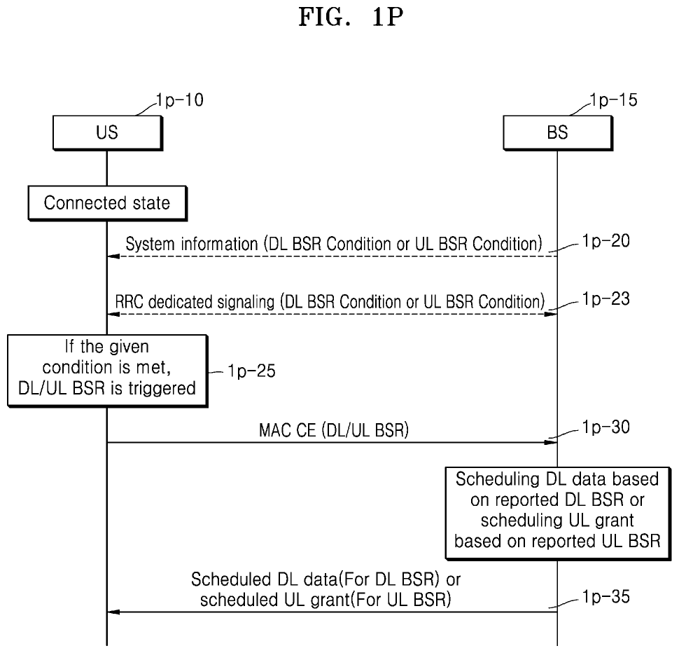

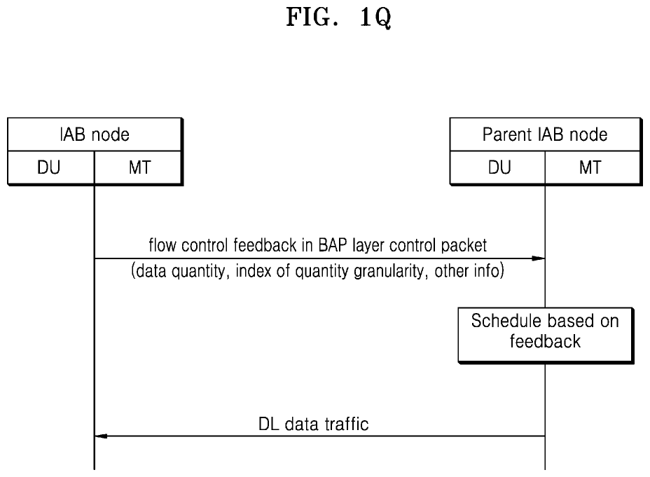

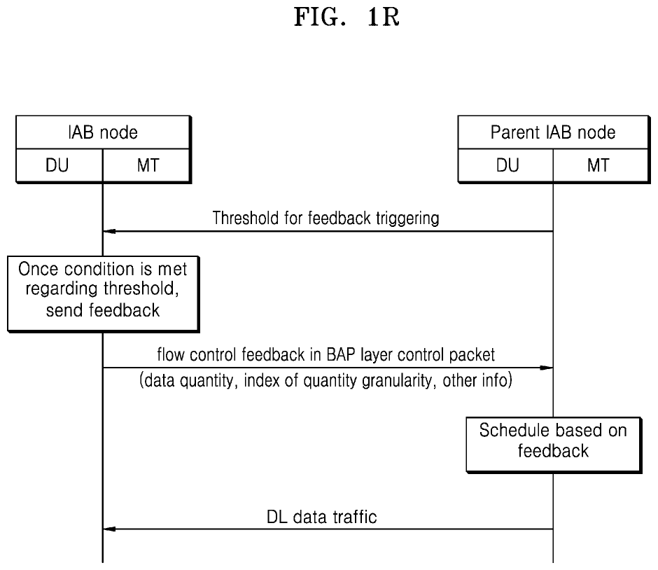

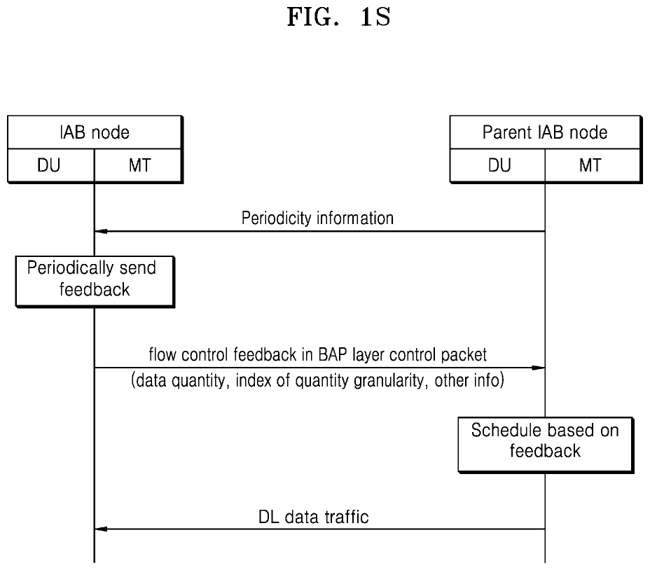

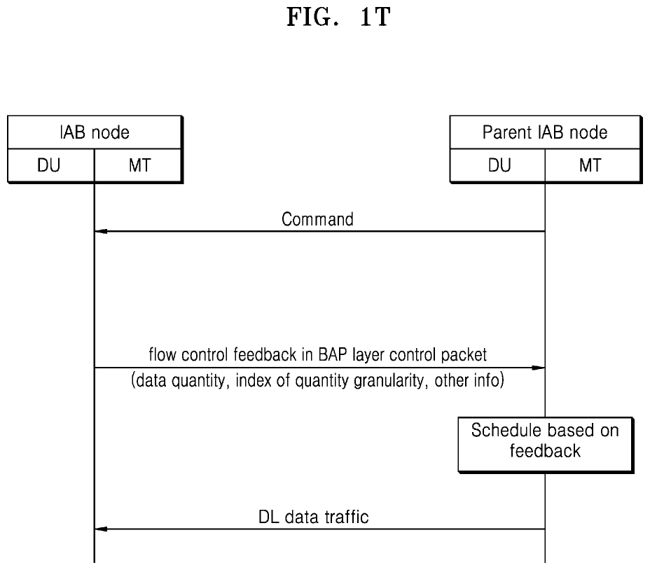

FIG. 1A shows a structure of a long term evolution (LTE) system, according to some embodiments of the disclosure.

Referring to FIG. 1, a radio access network of the LTE system may include evolved Node Bs (hereinafter, also referred to as ENBs, Node Bs, or base stations) 1a-05, 1a-10, 1a-15, and 1a-20, a mobility management entity (MME) 1a-25, and a serving gateway (S-GW) 1a-30. A UE (user equipment or terminal) 1a-35 may access an external network via the ENB 1a-05, 1a-10, 1a-15, or 1a-20, and the S-GW 1a-30.

In FIG. 1A, the ENBs 1a-05 to 1a-20 may correspond to the existing node Bs in a universal mobile telecommunication system (UMTS). The ENB may be connected to the UE 1a-35 via a wireless channel, and may play a more sophisticated role than the existing node B does. In the LTE system, all user traffic including real-time services such as Voice over IP (VoIP) may be served on shared channels. Accordingly, there may be a need for a device to aggregate information about buffer status of UEs, available transmission power status, a channel condition, etc., together and schedule them, and the ENB 1a-05 to 1a-20 may serve as the device. A single ENB may generally control a number of cells. To achieve e.g., 100 Mbps of transmission speed, the LTE system may use orthogonal frequency division multiplexing (OFDM) in e.g., 20 MHz of bandwidth as a radio access technology. Furthermore, the ENB may apply an adaptive modulation and coding (AMC) scheme that determines a modulation scheme and channel coding rate according to a channel condition of the UE. The S-GW 1a-30 may be a device to provide data bearers adding or releasing data bearers under the control of the MME 1a-25. The MME 1a-25 is a device responsible for various control functions as well as mobility management functionality for the UE, and may be connected to a number of BSs.

FIG. 1B shows a radio protocol architecture of an LTE system, according to some embodiments of the disclosure;

Referring to FIG. 1B, the radio protocol for an LTE system may include, for each of the UE and the ENB, a packet data convergence protocol (PDCP) 1b-05 or 1b-40, a radio link control (RLC) 1b-10 or 1b-35, and a medium access control (MAC) 1b-15 or 1b-30. The PDCP may be responsible for operations such as IP header compression/reconstruction. The main functions of the PDCP may be summarized as follows: It is, of course, not limited thereto.
header compression and decompression function (e.g., header compression and decompression: ROHC only)
user data transfer function
sequential delivery function (e.g., in-sequence delivery of upper layer Packet Data Units (PDUs) at PDCP re-establishment procedure for RLC AM)
reordering function (e.g., for split bearers in DC (only support for RLC AM): PDCP PDU routing for transmission and PDCP PDU reordering for reception)
duplicate detection function (e.g., duplicate detection of lower layer SDUs at PDCP re-establishment procedure for RLC AM)
retransmission function (e.g., retransmission of PDCP SDUs at handover and, for split bearers in DC, of PDCP PDUs at PDCP data-recovery procedure, for RLC AM)
ciphering and deciphering function
timer-based SDU discard function (e.g., timer-based SDU discard in uplink)

In some embodiments, the RLC 1b-10 or 1b-35 may reconfigure a PDCP packet data unit (PDU) into a suitable size to perform e.g., an ARQ operation. The main functions of the RLC may be summarized as follows: It is, of course, not limited thereto.
data transfer function (e.g., transfer of upper layer PDUs)
ARQ function (e.g., Error Correction through ARQ (only for AM data transfer))
concatenation, segmentation, and reassembling function (e.g., concatenation, segmentation and reassembly of RLC SDUs (only for UM and AM data transfer))
re-segmentation function (e.g., re-segmentation of RLC data PDUs (only for AM data transfer))
reordering function (e.g., reordering of RLC data PDUs (only for UM and AM data transfer))
duplicate detection function (e.g., duplicate detection (only for UM and AM data transfer))
error detection function (e.g., protocol error detection (only for AM data transfer))
RLC SDU discard function (e.g., RLC SDU discard (only for UM and AM data transfer))
RLC re-establishment function

In some embodiments, the MAC layer 1b-15 or 1b-30 may be connected to a number of RLC layer entities configured in a single UE, for multiplexing RLC PDUs to an MAC PDU and demultiplexing RLC PDUs from a MAC PDU. The main functions of the MAC layer 1b-15 or 1b-30 may be summarized as follows: It is, of course, not limited to the following example.
mapping function (e.g., mapping between logical channels and transport channels)
multiplexing and demultiplexing function (e.g., multiplexing/demultiplexing of MAC SDUs belonging to one or different logical channels into/from transport blocks (TB) delivered to/from the physical layer on transport channels)
scheduling information report function
HARQ function (e.g., error correction through HARQ)
logical channel priority control function (e.g., priority handling between logical channels of one UE)
UE priority control function (e.g., priority handling between UEs by means of dynamic scheduling)
MBMS service identification function
transport format selection function
padding function

In some embodiments, a physical layer 1b-20 or 1b-25 may perform channel coding and modulation on higher layer data, form the data into OFDM symbols and transmit them on a radio channel, or may demodulate OFDM symbols received on a radio channel, perform channel decoding on them and transmit the result to a higher layer. It is, of course, not limited to the following example.

FIG. 1C shows a structure of a next generation mobile communication system, according to some embodiments of the disclosure.

Referring to FIG. 1C, a radio access network of the next generation mobile communication (hereinafter, NR or 2g) system may include a new radio node B, hereinafter, referred to as an NR gNB or NR base station) 1c-10, and a new radio core network (NR CN) 1c-05. A new radio UE (NR UE or UE) 1c-15 may access an external network via the NR gNB 1c-10 and the NR CN 1c-05.

In FIG. 1C, the NR gNB 1c-10 may correspond to an evolved Node B (eNB) of the existing LTE system. The NR gNB may be connected to the NR UE 1c-15 via a wireless channel, and may provide much better service than the existing node B does. In the NR system, all user traffic may be served on shared channels. Accordingly, there may be a need for a device to aggregate information about buffer status of UEs, available transmission power status, a channel condition, etc., together and schedule them, and the NR gNB 1c-10 may serve as the device. A single NR gNB may control a number of cells. In the NR system, to achieve ultra high-speed data transmission compared to the current LTE, bandwidth greater than the current maximum bandwidth may be applied. Furthermore, a beamforming technology may be additionally used with a radio access technology employing OFDM.

Furthermore, in some embodiments, the NR gNB may employ an adaptive modulation and coding (AMC) scheme that determines a modulation scheme and channel coding rate according to a channel condition of the UE. The NR CN 1c-05 may perform such functions as supporting mobility, setting up a bearer, setting quality of service (QoS), etc. The NR CN 1c-05 is a device responsible for various control functions as well as mobility management functionality for the UE, and may be connected to a number of BSs. Moreover, the NR system may cooperate with the existing LTE system, in which case the NR CN may be connected to an MME 1c-25 through a network interface. The MME may be connected to an existing BS, eNB 1c-30.

FIG. 1D shows a radio protocol architecture of an NR system, according to some embodiments of the disclosure.

Referring to FIG. 1D, a radio protocol for the NR system includes for each of a UE and an NR gNB, an NR service data adaptation protocol (SDAP) 1d-01 or 1d-45, an NR PDCP 1d-05 or 1d-40, an NR RLC 1d-10 or 1d-35, and an NR MAC 1d-15 or 1d-30.

In some embodiments, main functions of the NR SDAP 1d-01 or 1d-45 may include some of the following functions: It is, of course, not limited to the following example.
user plane data transfer function
function of mapping between a QoS flow and a data bearer (DRB) for both DL and UL
function of marking QoS flow ID for both UL and DL
function of mapping of a reflective QoS flow to a data bearer (DRB) for UL SDAP PDUs

For an SDAP layer entity, the UE may receive configuration of whether to use a header of the SDAP layer entity or whether to use a function of the SADP layer entity for each PDCP layer entity, each bearer or each logical channel in a radio resource control (RRC) message. When the SDAP layer entity is configured with an SDAP header, a 1-bit non-access stratum (NAS) reflective QoS (NAS reflective QoS) indicator and a 1-bit access stratum (AS) reflective QoS (AS reflective QoS) indicator may indicate for the UE to update or reconfigure the mapping information between the UL and DL QoS flow and the data bearer. In some embodiments, the SDAP header may include QoS flow ID information indicating QoS. In some embodiments, the QoS information may be used for data process priority, scheduling, etc., for smoother services.

In some embodiments, main functions of the NR PDCP 1d-05 or 1d-40 may include some of the following functions: It is, of course, not limited to the following example.
header compression and decompression function (e.g., header compression and decompression: ROHC only)
user data transfer function
sequential delivery function (e.g., in-sequence delivery of upper layer PDUs)
non-sequential delivery function (e.g., out-of-sequence delivery of upper layer PDUs)
reordering function (e.g., PDCP PDU reordering for reception)
duplicate detection function (e.g., duplicate detection of lower layer SDUs)
retransmission function (e.g., retransmission of PDCP SDUs)
ciphering and deciphering function
timer-based SDU discard function (e.g., timer-based SDU discard in uplink)

In the above description, the reordering function of the NR PDCP device may refer to a function of reordering PDCP PDUs received from a lower layer based on PDCP sequence numbers (SNs). The reordering function of the NR PDCP device may include a function of delivering data to a higher layer in the reordered sequence or delivering the data directly to the higher layer without considering the sequence, a function of reordering the sequence to record missing PDCP PDUs, a function of reporting status of missing PDCP PDUs to a transmitting end, or a function of requesting retransmission of missing PDCP PDUs.

In some embodiments, main functions of the NR RLC 1d-10 or 1d-35 may include some of the following functions: It is, of course, not limited to the following example.
data transfer function (e.g., transfer of upper layer PDUs)
sequential delivery function (e.g., in-sequence delivery of upper layer PDUs)
non-sequential delivery function (e.g., out-of-sequence delivery of upper layer PDUs)
ARQ function (e.g., error correction through ARQ)
concatenation, segmentation, and reassembling function (e.g., concatenation, segmentation and reassembly of RLC SDUs)
re-segmentation function (e.g., re-segmentation of RLC data PDUs)
reordering function (e.g., reordering of RLC data PDUs)
duplicate detection function
error detection function (e.g., protocol error detection)
RLC SDU discard function
RLC re-establishment function

In the aforementioned description, the sequential delivery function of the NR RLC device may refer to a function of delivering RLC SDUs received from a lower layer to a higher layer in sequence. When several RLC SDUs split from an original RLC SDU are received, the sequential (in-sequence) delivery of the NR RLC device may include a function of re-assembling them and delivering the result.

The sequential delivery function of the NR RLC device may include a function of reordering the received RLC PDUs based on RLC sequence numbers (SNs) or PDCP SNs, a function of reordering the sequence to record missing RLC PDUs, a function of reporting status of missing RLC PDUs to a transmitting end, or a function of requesting retransmission of missing PDCP PDUs.

The sequential delivery function of the NR RLC device may include, when there is a missing RLC SDU, a function of delivering only RLC SDUs before the missing RLC SDU to a higher layer in sequence.

The sequential delivery function of the NR RLC device may include, when a certain timer has been expired even though there is a missing RLC SDU, a function of delivering all the received RLC SDUs to a higher layer in sequence before the timer is started.

The sequential delivery function of the NR RLC device may include, when a certain timer has been expired even though there is a missing RLC SDU, a function of delivering all the RLC SDUs received until the present time to a higher layer in sequence.

The NR RLC device may process the RLC PDUs out of sequence from the sequence numbers but in reception order, and deliver the result to the NR PDCP device.

When receiving segments, the NR RLC device may receive segments stored in the buffer or segments received later and reassemble them into a complete RLC PDU, and deliver the RLC PDU to the NR PDCP device.

The NR RLC layer may not include the concatenation function, and the concatenation function may be performed in the NR MAC layer or replaced with the multiplexing function of the NR MAC layer.

In the aforementioned description, the non-sequential delivery (out-of-sequence delivery) function of the NR RLC device may refer to a function of delivering RLC SDUs received from a lower layer directly to a higher layer without regard to the sequence of the RLC SDUs. The non-sequential delivery function of the NR RLC device may include, when several RLC SDUs split from an original RLC SDU is received, a function of reassembling them and delivering the result. The non-sequential delivery function of the NR RLC device may include a function of storing RLC SNs or PDCP SNs of the received RLC PDUs and ordering the sequence to record missing RLC PDUs.

In some embodiments, the NR MAC 1d-15 or 1d-30 may be connected to multiple NR RLC layer entities configured in the same UE, and main functions of the NR MAC may include some of the following functions: It is, of course, not limited to the following example.
mapping function (e.g., mapping between logical channels and transport channels)
multiplexing and demultiplexing function (e.g., multiplexing/demultiplexing of MAC SDUs)
scheduling information report function
HARQ function (e.g., error correction through HARQ)
logical channel priority control function (e.g., priority handling between logical channels of one UE)
UE priority control function (e.g., priority handling between UEs by means of dynamic scheduling)
MBMS service identification function
transport format selection function
padding function

The NR PHY layer 1d-20 or 1d-25 may perform channel coding and modulation on higher layer data, form the data into OFDM symbols and transmit them on a radio channel, or may demodulate OFDM symbols received on a radio channel, perform channel decoding on them and transmit the result to a higher layer.

FIG. 1E is a block diagram illustrating an internal structure of a UE, according to some embodiments of the disclosure.

Referring to FIG. 1E, a UE may include a radio frequency (RF) processor 1e-10, a baseband processor 1e-20, a storage 1e-30, and a controller 1e-40. It is, of course, not limited thereto, and the UE may include more or fewer components than in FIG. 1E.

The RF processor 1e-10 may perform functions, such as band conversion, amplification, etc., of a signal to transmit or receive the signal on a radio channel. Specifically, the RF processor 1e-10 may up-convert a baseband signal provided from the baseband processor 1e-20 to an RF band signal for transmission through an antenna, and down-convert an RF band signal received through the antenna to a baseband signal. For example, the RF processor 1e-10 may include a transmit filter, a receive filter, an amplifier, a mixer, an oscillator, a digital to analog converter (DAC), an analog to digital converter (ADC), etc. It is, of course, not limited thereto. Although a single antenna is shown in FIG. 1e, the UE may be equipped with a plurality of antennas. The RF processor 1e-10 may also include a plurality of RF chains. Furthermore, the RF processor 1e-10 may perform beamforming. For beamforming, the RF processor 1e-10 may control the phase and amplitude of each signal to be transmitted or received through a plurality of antennas or antenna elements. Furthermore, the RF processor 1e-10 may perform multiple-input-multiple-output (MIMO), and may receive a number of layers during the MIMO operation.

The baseband processor 1e-20 may perform conversion between a baseband signal and a bit sequence based on a physical layer standard of the system. For example, for data transmission, the baseband processor 1e-20 may generate complex symbols by encoding and modulating a bit sequence for transmission. Furthermore, for data reception, the baseband processor 1e-20 may reconstruct a received bit sequence by demodulating and decoding the baseband signal provided from the RF processor 1e-10. For example, in a case of conforming to an orthogonal frequency divisional multiplexing (OFDM) scheme, for data transmission, the baseband processor 1e-20 generates complex symbols by encoding and modulating a bit sequence for transmission, maps the complex symbols to subcarriers, and performs inverse fast Fourier transform (IFFT) operation and cyclic prefix (CP) insertion to construct OFDM symbols. Furthermore, for data reception, the baseband processor 1e-20 may divide a baseband signal provided from the RF processor 1e-10 into OFDM symbol units, reconstruct the signals mapped to the subcarriers through fast Fourier transform (FFT) operation and then reconstruct a received bit sequence through demodulation and decoding.

The baseband processor 1e-20 and the RF processor 1e-10 transmit and receive signals as described above. The baseband processor 1e-20 and the RF processor 1e-10 may be referred to as a transmitter, a receiver, a transceiver, or a communicator. Further, at least one of the baseband processor 1e-20 and the RF processor 1e-10 may include many different communication modules to support many different radio access technologies. Furthermore, at least one of the baseband processor 1e-20 and the RF processor 1e-10 may include different communication modules to process different frequency band signals. For example, the different radio access technologies may include a WLAN, e.g., the IEEE 802.11, a cellular network, e.g., LTE, etc. Furthermore, the different frequency bands may include a super high frequency (SHF) band, e.g., 2.NRHz, NRhz, and millimeter wave (mmwave) band, e.g., 60 GHz. The UE may use the baseband processor 1e-20 and the RF processor 1e-10 to transmit or receive signals which may include control information and data.

The storage 1e-30 stores a basic program for operation of the UE, an application program, data such as configuration information. In particular, the storage 1e-30 may store information regarding a second access node that performs wireless communication using a second radio access technology. The storage 1e-30 provides data stored therein at the request of the controller 1e-40. The storage 1e-30 may include a storage medium such as a read only memory (ROM), a random access memory (RAM), a hard disk, a compact disk ROM (CD-ROM), and a digital versatile disc (DVD), or a combination of storage mediums. Moreover, the storage 1e-30 may include a plurality of memories.

The controller 1e-40 may control general operation of the UE. For example, the controller 1e-40 controls the baseband processor 1e-20 and the RF processor 1e-10 for signal transmission or reception. The controller 1e-40 also records or reads data onto or from the storage 1e-40. For this, the controller 1e-40 may include at least one processor. For example, the controller 1e-40 may include a communication processor (CP) for controlling communication and an application processor (AP) for controlling a higher layer such as an application program. At least one component in the UE may be implemented in a single chip.

FIG. 1F is a block diagram illustrating a structure of an NR base station (NR BS), according to some embodiments of the disclosure.

Referring to FIG. 1F, the BS may include an RF processor 1f-10, a baseband processor 1f-20, a backhaul communicator 1f-30, a storage 1f-40, and a controller 1f-50. It is, of course, not limited thereto, and the BS may include more or fewer components than in FIG. 1F.

The RF processor 1f-10 may perform functions, such as band conversion, amplification, etc., of a signal to transmit or receive the signal on a radio channel Specifically, the RF processor 1f-10 up-converts a baseband signal provided from the baseband processor 1f-20 to an RF band signal for transmission through an antenna, and down-converts an RF band signal received through the antenna to a baseband signal. For example, the RF processor 1f-10 may include a transmit filter, a receive filter, an amplifier, a mixer, an oscillator, a DAC, an ADC, etc. Although a single antenna is shown in FIG. 1F, the RF processor 1f-10 may be equipped with a plurality of antennas. The RF processor 1f-10 may also include a plurality of RF chains. Furthermore, the RF processor 1f-10 may perform beamforming. For beamforming, the RF processor 1f-10 may control the phase and amplitude of each signal to be transmitted or received through a plurality of antennas or antenna elements. The RF processor may perform downlink MIMO operation by transmitting one or more layers.

The baseband processor 1f-20 may perform conversion between a baseband signal and a bit sequence based on a physical layer standard of a first radio access technology. For example, for data transmission, the baseband processor 1f-20 may generate complex symbols by encoding and modulating a bit sequence for transmission. Furthermore, for data reception, the baseband processor 1f-20 may reconstruct a received bit sequence by demodulating and decoding the baseband signal provided from the RF processor 1f-10. For example, when conforming to an OFDM scheme, for data transmission, the baseband processor 1f-20 may generate complex symbols by encoding and modulating a bit sequence for transmission, map the complex symbols to subcarriers, and then reconstruct OFDM symbols by IFFT operation and CP insertion. Furthermore, for data reception, the baseband processor 1f-20 may divide a baseband signal provided from the RF processor 1f-10 into OFDM symbol units, reconstruct the signals mapped to the subcarriers through FFT operation and then reconstruct a received bit sequence through demodulation and decoding. The baseband processor 1f-20 and the RF processor 1f-10 transmit and receive signals as described above. The baseband processor 1f-20 and the RF processor 1f-10 may be referred to as a transmitter, a receiver, a transceiver, or a communicator. The BS may use the baseband processor 1f-20 and the RF processor 1f-10 to transmit or receive signals to or from a UE, and the signals may include control information and data.

The backhaul communicator 1f-30 may provide an interface for communicating with other nodes in the network. Specifically, the backhaul communicator 1f-30 may convert a bit sequence to be transmitted from this primary BS to another node, e.g., a secondary BS, a core network, etc., into a physical signal, and convert a physical signal received from another node to a bit sequence. The backhaul communicator 1f-30 may be included in a communication module.

The storage 1f-40 may store a basic program for operation of the NR BS, an application program, data such as configuration information. The storage 1f-40 may store information about a bearer allocated to a connected UE, measurements reported from the UE, etc. Furthermore, the storage 1f-40 may store information used as a criterion for determining whether to provide or stop multi-connection for the UE. The storage 1f-40 may provide data stored therein at the request of the controller 1f-50. The storage 1f-40 may include a storage medium such as a ROM, a RAM, a hard disk, a CD-ROM, and a DVD, or a combination of storage mediums. Moreover, the storage 1f-40 may include a plurality of memories. In some embodiments, the storage 1f-40 may store a program to perform a method of reporting buffer status according to the disclosure.

The controller 1f-50 may control general operation of the BS. For example, the controller 1f-50 controls the baseband processor 1f-20 and the RF processor 1f-10 or the backhaul communicator 1f-30 for signal transmission or reception. The controller 1f-50 also records or reads data onto or from the storage 1f-40. For this, the controller 1f-50 may include at least one processor. At least one component in the BS may be implemented in a single chip.

First, in the disclosure, the expression ‘DL/UL buffer status report (BSR)’ refers to a DL BSR or a UL BSR, and operations for the DL BSR and the UL BSR do not relate to each other. The parallel use of DL/UL in the term DL/UL BSR is to avoid repetition of the overlapping term that is otherwise DL BSR or UL BSR.

When the UE has a mobile terminal (MT) function of an IAB node and knows of having the MT function, the UE may perform connection to a BS that is able to support an MT function of an IAB node. The UE may access an IAB node for a BS, which broadcasts a capability of the IAB node which may support the MT function, or when there is no broadcast about a capability of the IAB node, the UE may access the IAB node for a BS and then deliver information about the UE's interest or function about the IAB MT to ask the BS whether to support an IAB related operation. With this procedure, only when both the UE and the BS know of the MT function and distributed unit (DU) function of the IAB node or IAB BS, they may perform DL BSR or UL BSR operation.

FIG. 1G is a flowchart illustrating an occasion of receiving IAB UE configuration information transmitted by a BS as one of conditions in which DL BSR or UL BSR may be operated, according to some embodiments of the disclosure.

A UE 1g-5 receives system information 1g-20 in an idle state 1g-15 before accessing a BS 1g-10. The system information may include IAB related information. Upon reception of the information, the UE establishes a connection 1g-30 through a connection setup process 1g-25, applies IAB configuration information based on the given IAB configuration information 1g-35, and accordingly, performs a DL/UL BSR operation 1g-40. In this procedure, instead of receiving the system information 1g-20, connection is established 1g-30, and then IAB related configuration information may be delivered in RRC dedicated signaling 1g-33. In the case of delivering in the RRC dedicated signaling, an additional RRC reconfiguration complete message is transmitted to the BS 1g-34, and then operations 1g-35 and 1g-40 may be performed.

Furthermore, performing the DL/UL BSR operation 1g-40 may have different details depending on when the BS dynamically requests a DL/UL BSR or when a certain condition for the DL/UL BSR is given to the UE. The DL/UL BSR operation 1g-40 will be described in detail in connection with FIGS. 1J and 1K.

In operation 1g-20 and 1g-33, configuration information of the IAB node may be delivered. The configuration information of the IAB node may include at least one of an indicator indicating whether to support DL BSR for IAB, an indicator indicating whether to support UL BSR for IAB, a buffer size threshold based on which to perform the DL or UL BSR operation, or time information for the DL or UL BSR operation. An indicator indicating whether a buffer size index and the corresponding buffer size range information to be used for the DL or UL BSR is based on a table for IAB or a table for normal BSR may also be included, without being limited thereto.

FIG. 1H is a flowchart illustrating an occasion when a UE transmits information regarding an IAB capability as one of conditions in which DL BSR or UL BSR may be operated, according to some embodiments of the disclosure.

When a UE 1h-5 establishes a connection through a connection setup process 1h-25 in an idle state 1h-15 before accessing a BS 1h-10, the BS may deliver a message 1h-30 requesting capability information of the UE. Upon reception of the message 1h-30, the UE 1h-5 may inform the BS of its IAB related capability information in a separate message delivering the capability information of the UE 1h-5. Based on the received message delivering the UE capability information, the BS 1h-10 may know that the UE 1h-5 is an MT of an IAB and know of the capability about the BSR operation for IAB 1h-40. Based on the capability information of the UE 1h-5, the BS 1h-10 may deliver IAB related configuration information in RRC dedicated signaling, 1h-45. Upon reception of this, the UE is configured based on the information and transmits an RRC reconfiguration complete message to the BS, 1h-50. Subsequently, the UE performs a DL/UL BSR operation 1h-55. The DL/UL BSR operation 1h-55 will be described in detail in connection with FIGS. 1J and 1K.

Information delivered in operation 1h-35 may be the IAB related capability information of the UE, which may include information about whether to support the DL/UL BSR and what table may be used for relations between the buffer size index and the buffer size range when the DL/UL BSR is supported, etc. Furthermore, the IAB related capability information of the UE may include band combination information to be used by the IAB UE.

In operation 1h-45, configuration information of the IAB node may be delivered. The configuration information of the IAB node may include at least one of an indicator indicating whether to support DL BSR for IAB, an indicator indicating whether to support UL BSR for IAB, a buffer size threshold based on which to perform the DL or UL BSR operation, or time information for the DL or UL BSR operation. The configuration information of the IAB node may also include an indicator indicating whether a buffer size index and the corresponding buffer size range information to be used for the DL or UL BSR is based on a table for IAB or a table for normal BSR. It is, however, not limited to the example.

In some embodiments, given an object of a report granularity unit, which is a unit to be reported by calculating a data quantity, a DL/UL BSR format may include an indication of an object required to be reported among a plurality of objects and information about the data quantity corresponding to the object. The report granularity is a report unit of a BSR, which may be one of a BH RLC channel or a BH RLC channel group, a logical channel or a logical channel group, and a DRB for each UE or a UE DRB group in DL. A report data type of the BSR, which is information about a data quantity to be reported, may consider a desired buffer size, buffer status, and a desired data rate.

FIG. 1I illustrates a case with a DL/UL logical channel group for report granularity and desired buffer size for data quantity as a type of DL/UL BSR format mode, according to some embodiments of the disclosure.

In FIG. 1I, a DL/UL BSR is signaled as a control element. The DL/UL BSR may be recognized with a logical channel ID included in an MAC subheader for an uplink shared channel (UL-SCH) to be distinguished from MAC CEs transmitted on a different UL-SCH. In some embodiments, a detailed DL/UL BSR format may conform to a long BSR format of LTE. Specifically, the DL/UL BSR format may include report granularity and desired buffer size fields. In FIG. 1I, for report granularity, an LCG_i field is taken as an example. The LCG_i field may indicate the presence of a desired buffer size field for a logical channel group i. In some embodiments, when the LCG_i field is set to 1, it indicates that there is a desired buffer size field reported for the corresponding logical channel group i. When the LCG_i field is set to 0, it indicates that no desired buffer size field is reported for the corresponding logical channel group i.

Logical channel group ID (LCG ID) refers to a predefined group of logical channels of the UE. As for the LCG_i, i may refer to each logical channel group ID, which may be defined as an integer from 0 to (a multiple of 8)−1. LCG_i field allocation parts may be allocated in octets. For example, bits allocated the LCG_i field may include a full set of OCTET1, a full set of OCTETs 1 and 2, or a full set of OCTETs 1, 2, and 3.

In some embodiments, information to fill in the desired buffer size field may be separated for a DL BSR occasion and a UL BSR occasion. For the DL BSR, information to fill in the desired buffer size field refers to a maximum DL data amount for the reporting IAB node to receive in future with respect to the report granularity, which may be in bytes.

For the UL BSR, information to fill in the desired buffer size field indicates a total amount of UL data available or effective (or currently present) for transmission. For the UL BSR, information to fill in the desired buffer size field is calculated in a data volume calculation method that conforms to TS 38.322 and TS 38.323 for all the logical channels belonging to a logical channel group when the UL BSR is triggered. An amount of data of the desired buffer size field may be represented in bytes. Furthermore, the desired buffer size may be calculated without considering the adaptation layer, RLC, and MAC header. In some embodiments, the desired buffer size field may be 8-bit long. Desired buffer size fields may be included in ascending order based on the LCG_i. (Buffer Size fields are included in ascending order based on the LCGi.)

The desired buffer size field may be located behind an octet allocated the LCG_i in a bitstream of a DL/UL BSR MAC CE. A value of the desired buffer size field may be an index value to represent a total amount of data, and each index may represent a range of desired buffer size values. The value of 8-bit buffer size field and the range may be represented in the following table. It is, of course, not limited to the following example.

| Index | BS value |
|---|---|
| 0 | 0 |
| 1 | ≤10 |
| 2 | ≤11 |
| 3 | ≤12 |
| 4 | ≤13 |
| 5 | ≤14 |
| 6 | ≤15 |
| 7 | ≤16 |
| 8 | ≤17 |
| 9 | ≤18 |
| 10 | ≤19 |
| 11 | ≤20 |
| 12 | ≤22 |
| 13 | ≤23 |
| 14 | ≤25 |
| 15 | ≤26 |
| 16 | ≤28 |
| 17 | ≤30 |
| 18 | ≤32 |
| 19 | ≤34 |
| 20 | ≤36 |
| 21 | ≤38 |
| 22 | ≤40 |
| 23 | ≤43 |
| 24 | ≤46 |
| 25 | ≤49 |
| 26 | ≤52 |
| 27 | ≤55 |
| 28 | ≤59 |
| 29 | ≤62 |
| 30 | ≤66 |
| 31 | ≤71 |
| 32 | ≤75 |
| 33 | ≤80 |
| 34 | ≤85 |
| 35 | ≤91 |
| 36 | ≤97 |
| 37 | ≤103 |
| 38 | ≤110 |
| 39 | ≤117 |
| 40 | ≤124 |
| 41 | ≤132 |
| 42 | ≤141 |
| 43 | ≤150 |
| 44 | ≤160 |
| 45 | ≤170 |
| 46 | ≤181 |
| 47 | ≤193 |
| 48 | ≤205 |
| 49 | ≤218 |
| 50 | ≤233 |
| 51 | ≤248 |
| 52 | ≤264 |
| 53 | ≤281 |
| 54 | ≤299 |
| 55 | ≤318 |
| 56 | ≤339 |
| 57 | ≤361 |
| 58 | ≤384 |
| 59 | ≤409 |
| 60 | ≤436 |
| 61 | ≤464 |
| 62 | ≤494 |
| 63 | ≤526 |
| 64 | ≤560 |
| 65 | ≤597 |
| 66 | ≤635 |
| 67 | ≤677 |
| 68 | ≤720 |
| 69 | ≤767 |
| 70 | ≤817 |
| 71 | ≤870 |
| 72 | ≤926 |
| 73 | ≤987 |
| 74 | ≤1051 |
| 75 | ≤1119 |
| 76 | ≤1191 |
| 77 | ≤1269 |
| 78 | ≤1351 |
| 79 | ≤1439 |
| 80 | ≤1532 |
| 81 | ≤1631 |
| 82 | ≤1737 |
| 83 | ≤1850 |
| 84 | ≤1970 |
| 85 | ≤2098 |
| 86 | ≤2234 |
| 87 | ≤2379 |
| 88 | ≤2533 |
| 89 | ≤2698 |
| 90 | ≤2873 |
| 91 | ≤3059 |
| 92 | ≤3258 |
| 93 | ≤3469 |
| 94 | ≤3694 |
| 95 | ≤3934 |
| 96 | ≤4189 |
| 97 | ≤4461 |
| 98 | ≤4751 |
| 99 | ≤5059 |
| 100 | ≤5387 |
| 101 | ≤5737 |
| 102 | ≤6109 |
| 103 | ≤6506 |
| 104 | ≤6928 |
| 105 | ≤7378 |
| 106 | ≤7857 |
| 107 | ≤8367 |
| 108 | ≤8910 |
| 109 | ≤9488 |
| 110 | ≤10104 |
| 111 | ≤10760 |
| 112 | ≤11458 |
| 113 | ≤12202 |
| 114 | ≤12994 |
| 115 | ≤13838 |
| 116 | ≤14736 |
| 117 | ≤15692 |
| 118 | ≤16711 |
| 119 | ≤17795 |
| 120 | ≤18951 |
| 121 | ≤20181 |
| 122 | ≤21491 |
| 123 | ≤22885 |
| 124 | ≤24371 |
| 125 | ≤25953 |
| 126 | ≤27638 |
| 127 | ≤29431 |
| 128 | ≤31342 |
| 129 | ≤33376 |
| 130 | ≤35543 |
| 131 | ≤37850 |
| 132 | ≤40307 |
| 133 | ≤42923 |
| 134 | ≤45709 |
| 135 | ≤48676 |
| 136 | ≤51836 |
| 137 | ≤55200 |
| 138 | ≤58784 |
| 139 | ≤62599 |
| 140 | ≤66663 |
| 141 | ≤70990 |
| 142 | ≤75598 |
| 143 | ≤80505 |
| 144 | ≤85730 |
| 145 | ≤91295 |
| 146 | ≤97221 |
| 147 | ≤103532 |
| 148 | ≤110252 |
| 149 | ≤117409 |
| 150 | ≤125030 |
| 151 | ≤133146 |
| 152 | ≤141789 |
| 153 | ≤150992 |
| 154 | ≤160793 |
| 155 | ≤171231 |
| 156 | ≤182345 |
| 157 | ≤194182 |
| 158 | ≤206786 |
| 159 | ≤220209 |
| 160 | ≤234503 |
| 161 | ≤249725 |
| 162 | ≤265935 |
| 163 | ≤283197 |
| 164 | ≤301579 |
| 165 | ≤321155 |
| 166 | ≤342002 |
| 167 | ≤364202 |
| 168 | ≤387842 |
| 169 | ≤413018 |
| 170 | ≤439827 |
| 171 | ≤468377 |
| 172 | ≤498780 |
| 173 | ≤531156 |
| 174 | ≤565634 |
| 175 | ≤602350 |
| 176 | ≤641449 |
| 177 | ≤683087 |
| 178 | ≤727427 |
| 179 | ≤774645 |
| 180 | ≤824928 |
| 181 | ≤878475 |
| 182 | ≤935498 |
| 183 | ≤996222 |
| 184 | ≤1060888 |
| 185 | ≤1129752 |
| 186 | ≤1203085 |
| 187 | ≤1281179 |
| 188 | ≤1364342 |
| 189 | ≤1452903 |
| 190 | ≤1547213 |
| 191 | ≤1647644 |
| 192 | ≤1754595 |
| 193 | ≤1868488 |
| 194 | ≤1989774 |
| 195 | ≤2118933 |
| 196 | ≤2256475 |
| 197 | ≤2402946 |
| 198 | ≤2558924 |
| 199 | ≤2725027 |
| 200 | ≤2901912 |
| 201 | ≤3090279 |
| 202 | ≤3290873 |
| 203 | ≤3504487 |
| 204 | ≤3731968 |
| 205 | ≤3974215 |
| 206 | ≤4232186 |
| 207 | ≤4506902 |
| 208 | ≤4799451 |
| 209 | ≤5110989 |
| 210 | ≤5442750 |
| 211 | ≤5796046 |
| 212 | ≤6172275 |
| 213 | ≤6572925 |
| 214 | ≤6999582 |
| 215 | ≤7453933 |
| 216 | ≤7937777 |
| 217 | ≤8453028 |
| 218 | ≤9001725 |
| 219 | ≤9586039 |
| 220 | ≤10208280 |
| 221 | ≤10870913 |
| 222 | ≤11576557 |
| 223 | ≤12328006 |
| 224 | ≤13128233 |
| 225 | ≤13980403 |
| 226 | ≤14887889 |
| 227 | ≤15854280 |
| 228 | ≤16883401 |
| 229 | ≤17979324 |
| 230 | ≤19146385 |
| 231 | ≤20389201 |
| 232 | ≤21712690 |
| 233 | ≤23122088 |
| 234 | ≤24622972 |
| 235 | ≤26221280 |
| 236 | ≤27923336 |
| 237 | ≤29735875 |
| 238 | ≤31666069 |
| 239 | ≤33721553 |
| 240 | ≤35910462 |
| 241 | ≤38241455 |
| 242 | ≤40723756 |
| 243 | ≤43367187 |
| 244 | ≤46182206 |
| 245 | ≤49179951 |
| 246 | ≤52372284 |
| 247 | ≤55771835 |
| 248 | ≤59392055 |
| 249 | ≤63247269 |
| 250 | ≤67352729 |
| 251 | ≤71724679 |
| 252 | ≤76380419 |
| 253 | ≤81338368 |
| 254 | >81338368 |
| 255 | Reserved |

Furthermore, in some embodiments, the value of 8-bit buffer size and the range may have a larger maximum BS value and an interval of a range of desired buffer size values indicated by each index may have a larger value than in the table.

Moreover, in some embodiments, mapping between the DL logical channel groups (or backhaul RLC channel groups) for DL BSR may be in the same way as for UL or may be differently determined by a central unit (CU).

FIG. 1J illustrates a case with a DL/UL logical channel for report granularity and desired buffer size for data quantity as another type of DL/UL BSR format mode, according to some embodiments of the disclosure.

Referring to FIG. 1J, for report granularity, an LC_i field is taken as an example. The LC_i field indicates the presence of a desired buffer size field for a logical channel i. When the LC_i field is set to 1, it indicates that there is a desired buffer size field reported for the corresponding logical channel i. When the LC_i field is set to 0, it indicates that no desired buffer size field is reported for the corresponding logical channel i.

Logical channel ID (LC ID) refers to a predefined logical channel of the UE. As for the LC_i, i may refer to each logical channel ID, which may be defined as an integer from 0 to (a multiple of 8)−1. LC_i field allocation parts may be allocated in octets. For example, bits allocated the LC_i field may include a full set of OCTET1, a full set of OCTETs 1 and 2, or a full set of OCTETs 1, 2, and 3.

In some embodiments, information to fill in the desired buffer size field may be separated for a DL BSR occasion and a UL BSR occasion. For the DL BSR, information to fill in the desired buffer size field refers to a maximum DL data amount for the reporting IAB node to receive in future with respect to the report granularity, which may be in bytes.

For the UL BSR, information to fill in the desired buffer size field indicates a total amount of UL data available or effective (or currently present) for transmission. For the UL BSR, information to fill in the desired buffer size field is calculated in a data volume calculation method that conforms to TS 38.322 and TS 38.323 for a single logical channel when the UL BSR is triggered. An amount of data of the desired buffer size field may be represented in bytes. Furthermore, the desired buffer size may be calculated without considering the adaptation layer, RLC, and MAC header. In some embodiments, the desired buffer size field may be 8-bit long. Desired buffer size fields may be included in ascending order based on the LC_i. (Buffer Size fields are included in ascending order based on the LC_i.)

The desired buffer size field may be located behind an octet allocated the LC_i in a bitstream of a DL/UL BSR MAC CE. A value of the desired buffer size field may be an index value to represent a total amount of data, and each index may represent a range of desired buffer size values. The value of 8-bit buffer size field and the range may be represented in the following table. It may follow the aforementioned table in connection with FIG. 1I. It is, of course, not limited to the aforementioned example.

FIG. 1K illustrates a case with a DL/UL BH RLC channel (or DL/UL BH RLC channel group) for report granularity and desired buffer size for data quantity as another type of DL/UL BSR format mode, according to some embodiments of the disclosure.

Referring to FIG. 1K, a backhaul RLC channel_i (or backhaul RLC channel group_i), i.e., BLC_i (or BLCG_i) field is taken as an example of report granularity. The BLC_i (or BLCG_i) field indicates the presence of a desired buffer size field for the BH RLC channel i (or BH RLC channel group i). When the BLC_i (or BLCG_i) field is set to 1, it indicates that there is a desired buffer size field reported for the corresponding BH RLC channel i (or BH RLC channel group i). When the BLC_i (or BLCG_i) field is set to 0, it indicates that no desired buffer size field is reported for the corresponding BH RLC channel i (or BH RLC channel group i).

The BLC_i (or BLCG_i) refers to a predefined backhaul RLC channel_i (or backhaul RLC channel group_i) of a UE. As for the BLC_i (or BLCG_i), i may refer to each backhaul RLC channel or (backhaul RLC channel group) ID, which may be defined as an integer from 0 to (a multiple of 8)−1. BLC_i (or BLCG_i) field allocation parts may be allocated in octets. For example, bits allocated the BLC_i (or BLCG_i) field may include a full set of OCTET1, a full set of OCTETs 1 and 2, or a full set of OCTETs 1, 2, and 3.

In some embodiments, information to fill in the desired buffer size field may be separated for a DL BSR occasion and a UL BSR occasion. For the DL BSR, information to fill in the desired buffer size field refers to a maximum DL data amount for the reporting IAB node to receive in future with respect to the report granularity, which may be in bytes.

For the UL BSR, information to fill in the desired buffer size field indicates a total amount of UL data available or effective (or currently present) for transmission. For the UL BSR, information to fill in the desired buffer size field is calculated in a data volume calculation method that conforms to TS 38.322 and TS 38.323 for a single backhaul RLC channel (or backhaul RLC channel group) when the UL BSR is triggered. An amount of data of the desired buffer size field may be represented in bytes. Furthermore, the desired buffer size may be calculated without considering the adaptation layer, RLC, and MAC header. In some embodiments, the desired buffer size field may be 8-bit long. Desired buffer size fields may be included in ascending order based on the BLC_i (or BLCG_i). (Buffer Size fields are included in ascending order based on the BLC_i (or BLCG_i).)

The desired buffer size field may be located behind an octet allocated the BLC_i (or BLCG_i) in a bitstream of a DL/UL BSR MAC CE. A value of the desired buffer size field may be an index value to represent a total amount of data, and each index may represent a range of desired buffer size values. The value of 8-bit buffer size field and the range may be represented in the following table. It may follow the aforementioned table in connection with FIG. H. It is, of course, not limited to the aforementioned example.

FIG. 1L illustrates a case with a DL/UL UE DRB (or DL/UL UE DRB group) for report granularity and desired buffer size for data quantity as another type of DL/UL BSR format mode, according to some embodiments of the disclosure. Here, UE DRB refers to a DRB of the UE that receives its service in a BS part of an IAB node. In denoting a DRB or DRB group, a DL BSR refers to a DL DRB and DL DRB group, and a UL BSR may refer to a UL DRB or UL DRB group.

Referring to FIG. 1L, a UE DRB_i field is taken as an example of the report granularity. UE DRB_i (or UE DRBG_i) field indicates the presence of a desired buffer size field for the UE DRB_i (or UE DRB group_i). When the UE DRB_i (or UE DRBG_i) field is set to 1, it indicates that there is a desired buffer size field reported for the corresponding UE DRB_i (or UE DRB group_i). When the UE DRB_i (or UE DRBG_i) field is set to 0, it indicates that no desired buffer size field is reported for the corresponding UE DRB_i (or UE DRB group_i).

As for the UE DRB_i (or UE DRBG_i), i may refer to each UE DRB (or UE DRB group) ID, which may be defined as an integer from 0 to (a multiple of 8)−1. UE DRB_i (or UE DRBG_i) field allocation parts may be allocated in octets. For example, bits allocated the UE DRB_i (or UE DRBG_i) field may include a full set of OCTET1, a full set of OCTETs 1 and 2, or a full set of OCTETs 1, 2, and 3.

In some embodiments, information to fill in the desired buffer size field may be separated for a DL BSR occasion and a UL BSR occasion. For the DL BSR, information to fill in the desired buffer size field refers to a maximum DL data amount for the reporting IAB node to receive in future with respect to the report granularity, which may be in bytes.

For the UL BSR, information to fill in the desired buffer size field indicates a total amount of UL data available or effective (or currently present) for transmission. For the UL BSR, information to fill in the desired buffer size field is calculated in a data volume calculation method that conforms to TS 38.322 and TS 38.323 for a single UE DRB (or UE DRB group) when the UL BSR is triggered. An amount of data of the desired buffer size field may be represented in bytes. Furthermore, the desired buffer size may be calculated without considering the adaptation layer, RLC, and MAC header. In some embodiments, the desired buffer size field may be 8-bit long. Desired buffer size fields may be included in ascending order based on the UE DRB_i (or UE DRBG_i). (Buffer Size fields are included in ascending order based on the UE DRB_i (or UE DRBG_i))

The desired buffer size field may be located behind an octet allocated the UE DRB_i (or UE DRBG_i) in a bitstream of a DL/UL BSR MAC CE. A value of the desired buffer size field may be an index value to represent a total amount of data, and each index may represent a range of desired buffer size values. The value of 8-bit buffer size field and the range may be represented in the following table. It may follow the aforementioned table in connection with FIG. 1I. It is, of course, not limited to the aforementioned example.

Next, an occasion where a data quantity to be reported may be buffer status or a desired data rate instead of the desired buffer size as in the BSR formats described above in connection with FIGS. 1I, 1J, 1K, and 1L will be considered.

In FIG. 1M, the report granularity may be one of a logical channel, a group of logical channels, a BH RLC channel, a group of BH RLC channels, a UE DRB, and a UE DRB group, and may be generally called report granularity. The data quantity to be reported in FIG. 1M may be buffer status. Specifically, a report granularity RG_i field indicates the presence of a buffer status field for report granularity i. When the RG_i field is set to 1, it indicates that there is a buffer status field reported for the RG i. When the RG_i field is set to 0, it indicates that no buffer size field is reported for the corresponding report granularity i.

As for the RG_i, i may refer to each report granularity ID, which may be defined as an integer from 0 to (a multiple of 8)−1. RG_i field allocation parts may be allocated in octets. For example, bits allocated the RG_i field may include a full set of OCTET1, a full set of OCTETs 1 and 2, or a full set of OCTETs 1, 2, and 3.

In some embodiments, information to fill in the buffer status field may be separated for a DL BSR occasion and a UL BSR occasion. For the DL BSR, the information to fill in the buffer status field is an index indicating a discrete level of an amount of DL data currently accumulated (buffered) for a memory or buffering capacity of the reporting IAB node for the report granularity, or a portion of DL data accumulated for the capacity.

For the UL BSR, information to fill in the buffer status field indicates a total amount of UL data available or effective (or currently present) for transmission. For the UL BSR, information to fill in the buffer status field is calculated in a data volume calculation method that conforms to TS 38.322 and TS 38.323 for all the logical channels belonging to an RG when the UL BSR is triggered. In some embodiments, the buffer status field may be 8-bit long. Buffer status fields may be included in ascending order based on the RG_i. (Buffer status fields are included in ascending order based on the RGi.)

In some embodiments, the buffer status field may be located behind an octet allocated the RG_i in a bitstream of a DL/UL BSR MAC CE. A value of the buffer status field may be an index value to represent a total amount of data, and each index may represent a range of portions that fill the buffer.

In FIG. 1N, the report granularity may be one of a logical channel, a group of logical channels, a BH RLC channel, a group of BH RLC channels, a UE DRB, and a UE DRB group, and may be generally called report granularity. The data quantity to be reported in FIG. 1N may correspond to a desired data rate. Specifically, a report granularity RG_i field indicates the presence of a desired data rate for report granularity i. When the RG_i field is set to 1, it indicates that there is a desired data rate field reported for the RG i. When the RG_i field is set to 0, it indicates that no desired data rate field is reported for the corresponding report granularity i.

As for the RG_i, i may refer to each report granularity ID, which may be defined as an integer from 0 to (a multiple of 8)−1. RG_i field allocation parts may be allocated in octets. For example, bits allocated the RG_i field may include a full set of OCTET1, a full set of OCTETs 1 and 2, or a full set of OCTETs 1, 2, and 3.

In some embodiments, information to fill in the desired data rate field may be separated for a DL BSR occasion and a UL BSR occasion. For the DL BSR, the information to fill in the desired data rate field refers to an amount of DL data wanted by the reporting IAB node to receive from an upstream IAB node for a certain time from when the DL BSR is transmitted in consideration of the current buffer status of the IAB node with respect to the report granularity. The unit may be a byte.

For the UL BSR, information to fill in the desired data rate field indicates a total amount of UL data available or effective (or currently present) for transmission. For the UL BSR, information to fill in the desired data rate field is calculated in a data volume calculation method that conforms to TS 38.322 and TS 38.323 for all the logical channels belonging to an RG when the UL BSR is triggered. In some embodiments, the desired data rate field may be 8-bit long. Desired data rate fields may be included in ascending order based on the RG_i. (desired data rate fields are included in ascending order based on the RGi.)

In some embodiments, the desired data rate field may be located behind an octet allocated the RG_i in a bitstream of a DL/UL BSR MAC CE. A value of the desired data rate field may be an index value to represent a range of a total amount of data required.

FIGS. 1O and 1P show occasions where the UE transmits a DL/UL BSR when the BS requests the DL/UL BSR directly or when the BS delivers a DL/UL BSR triggering condition in system information or dedicated signaling and the condition is met, according to some embodiments of the disclosure. In the former case that the BS requests the DL/UL BSR directly, a DL/UL BSR request MAC CE may be considered. The DL/UL BSR request MAC CE is an MAC CE carried on a DL-SCH channel transmitted by the BS. Specifically, the DL/UL BSR request may be signaled using an MAC CE identified with an LCID present in an MAC subheader for the DL-SCH. When the BS transmits the MAC CE that requests a DL/UL BSR on the DL-SCH, the UE may transmit a DL/UL BSR MAC CE to the serving BS.

FIG. 1O is a diagram of a procedure in which a BS directly triggers a UE with a DL/UL BSR request MAC CE in a DL/UL BSR triggering operation. A UE 1o-10 remains in a connected state to a BS 1o-15. The BS transmits an MAC CE to the UE 1o-10 on a DL-S CH for a certain reason, the MAC CE being one to instruct transmission of a DL/UL BSR. The UE may calculate a report data quantity (one of a currently accumulated buffer level, a desired buffer size, buffer status, or a desired data rate) required for the current report granularity (one of a logical channel, a logical channel group, a BH RLC channel, a BH RLC channel group, a UE DRB, and UE DRB group), and transmit it in an MAC CE on the UL-SCH (1o-25).

In some embodiments, for the DL BSR, the BS may schedule as much DL data as required (1o-28) and transmit them to the UE (1o-30). When the BS schedules as much DL data as required (1o-30), in a case that the data quantity reported in the previous DL BSR is a desired buffer size, the upstream IAB node (BS) 1o-15 that has received the report transmits as much data as the desired buffer size reported to the maximum with respect to the reported report granularity. In this case, the upstream IAB node 1o-15 may transmit a data quantity reported in every TTI, or timely distribute and transmit them depending on the status of the upstream IAB node 1o-15.

In the operation 1o-30, when the quantity reported in the previous DL BSR is the buffer status, the upstream IAB node 1o-15 may transmit data to fit a situation of the upstream IAB node according to each reported index or transmit a defined amount of data for each index.

Alternatively, when the data quantity reported in the DL BSR is the desired data rate, the upstream IAB node 1o-15 that has received the report may deliver to the maximum as much as the reported data rate by taking into account a scheduling state of the upstream IAB node 1o-15 for a set time from when the report is received. In this case, it may distribute and transmit data for a plurality of transmission times at scheduling intervals. The upstream IAB node 1o-15 may, however, transmit the reported data quantity for the predefined time. To report the desired data rate, the BS 1o-15 may configure the UE 1o-10 about what value is to be used as a certain time in advance. The configuration information for reporting the desired data rate may be provided in system information or RRC dedicated signaling. The UE may transmit DL data to a lower IAB node or a UE that the UE serves by its scheduling (1o-35).

For the UL BSR, the BS that has received the UL BSR schedules as much UL grant as required (1o-40) and transmits them to the UE 1o-43. The UE transmits UL data to the BS using the UL grant (1o-45). The DL BSR and the UL BSR are independent operations, so the operations shown in FIG. 1O may be performed separately for the DL BSR and for the UL BSR.

FIG. 1P shows a method of delivering a DL/UL BSR transmission condition of a UE by transmitting system information or a dedicated signal without a DL/UL BSR request MAC CE of the BS, according to some embodiments of the disclosure.

Referring to FIG. 1P, a UE 1p-10 may deliver a DL/UL BSR transmission condition such as DL/UL BSR configuration information to a serving BS 1p-15 using system information 1p-20 or an RRC dedicated signal 1p-23. For the transmission condition, threshold values for the RG (LCG, logical channel, UE DRB, UE DRB group, BH RLC channel, or BH RLC channel group) of a certain ID and a data quantity applied for the RG of the ID (buffer size, desired buffer size, buffer status, or desired data rate) may be given.

Upon reception of configuration information about the transmission condition of DL/UL BSR, the UE 1p-10 may transmit a DL/UL BSR (1p-30) when the buffer size of the RG is equal to or greater than the given threshold value (1p-25). Furthermore, in some other embodiments, when the BS delivers only the threshold value to the UE for the DL/UL BSR transmission condition, the UE may transmit the DL/UL BSR to the BS (1p-30) when a buffer size exceeds the threshold value for any RG owned by the UE itself (1p-25).

In some other embodiments, the BS may signal a certain time period value in system information (1p-20) or a dedicated signal (1p-23). When the UE receives the value, it may transmit the DL/UL BSR to the BS based on the time period.

When the transmission condition from the BS is met and the UE transmits a DL BSR, the BS schedules DL data based on the DL BSR and transmits the DL data to the UE (1p-35). When the UE transmits a UL BSR, the BS schedules a UL grant base on the UL BSR and transmits the UL grant to the UE (1p-35).

When a flow control command and feedback is executed by the MAC layer, the UE and the BS may receive a UE DRB ID or BH RLC channel and logical channel mapping information from the BAP layer and identify an index for granularity of each quantity. When a UE DRB id or BH RCL channel and logical channel mapping information are received through the BAP layer, a logical channel may not be identified with the index for the granularity of each quantity, so the object may be a UE DRB id or a BH RLC channel index. The BAP layer performs mapping between BH RCL channel and UE DRB.

In another embodiment, a DL BSR or DL flow control feedback operation may be performed by the backhaul adaptation protocol (BAP) layer instead of the MAC layer. In this case, information about the DL buffer status may be reported in a certain unit through a control signal of the BAP layer, as in FIGS. I, 1J, 1K, 1L, 1M, and IN. The information about the DL buffer status may include a data quantity, a data type, or an index for the quantity granularity.

Information about the data quantity may include the followings:
buffer size or size of data currently stored in DL buffer
desired buffer size, size of data to be stored in the buffer, which is determined by an IAB node delivering this flow control feedback, or available buffer size
desired data rate, or desired data rate transmitted from a parent IAB node determined by an IAB node delivering this feedback
above quantities may be signaled in parallel. Above quantities can be signaled in parallel.

Information about the data type may include the followings:
Data type—some information on data in buffers
QoS requirements for indicated granularity or BAP data packet
the number of hops left to a destination for indicated granularity or BAP data packet
effective time for which each BAP data packet may stay in the buffer
possibility of multiple transmission (i.e., retransmission) required until to the next hop based on a state of egress link e.

Index information about quantity granularity may include the followings:
Index of quantity granularity

Id of backhaul RLC channel (BH RLC channel id)

UE DRB id of UE connected to the IAB node or downstream IAB node (or a separate identifier set in the BAP layer for the UE DRB)

In FIG. 1Q, flow control feedback information for a control signal of the BAP layer is transmitted to the parent IAB node from the MT. In this case, the data quantity, index information of the quantity granularity, and data time information may be delivered. Upon receiving this information, the parent IAB node may schedule DL traffic for an IAB node corresponding to the MT.

There may be a method of triggering feedback for flow control on a condition basis, predefined time basis, or based on a request of a higher node.

In the condition based method, a BAP layer control signal may have the followings.

A threshold for a certain data quantity may be given. In an embodiment, a common threshold may be given for DL buffers with any quantity granularity, or a plurality of thresholds associated with a granularity index of a certain quantity may be delivered. In the former case that a common value is given, when data quantity values of all DL buffers (with any quantity granularity) is greater than the threshold, feedback is given, or when a data quantity value of any DL buffer (with any quantity granularity) is greater than the threshold, the IAB node may give the feedback. In the latter case that the plurality of thresholds are delivered, when the data quantity values of all DL buffers with the granularity indexes of the delivered thresholds are greater than the given thresholds for the respective granularity indexes, feedback is given, or when the data quantity values of all DL buffers with the granularity indexes of the delivered thresholds are compared with the respective thresholds and even a data quantity of one of the DL buffers is greater than the given threshold, the IAB node may perform flow control feedback.

In this case, the threshold and the granularity index information may be delivered from CU or from the parent IAB node. Further, in this case, a control layer used may be delivered in system information, an MAC control signal, or BAP control information from the parent node, or through F1-AP from the CU.

In FIG. 1R, the parent IAB node may deliver a granularity index and a threshold for feedback triggering to the IAB node through the signal layer. The IAB node may perform the flow control feedback operation as described above in connection with FIG. 1Q when the given threshold condition is met during operation. In the feedback operation, the data quantity, the data type information, the quantity granularity index information described above in connection with FIG. 1Q may be included. Upon reception of the information, the parent node schedules DL data traffic accordingly.

In addition, in another embodiment, the parent node may set a feedback report time as a condition to trigger feedback in the BAP control signal.

When the parent node configures a certain periodicity value for the IAB node, feedback may be transmitted one time during the periodicity from the moment the signal is received. In another embodiment, a correct transmission time and repetition time may be informed, so that transmission may be performed in the corresponding time and feedback may be constantly repeated.

In FIG. 1S, when the parent IAB node transmits the periodicity information, the IAB node having received the information may transmit feedback information to the parent IAB node at the given periodicity. The flow control feedback information may include the data quantity, the data type information, the quantity granularity index information described above in connection with FIG. 1Q. Upon reception of the information, the parent IAB node schedules DL data traffic accordingly.

In FIG. 1T, the flow control feedback may be reported according to a direct report command from a higher node.

The parent IAB node may transmit it in a BAP layer signal. For a content of the command, of what are declared in FIG. 1Q, the parent IAB node may give index information about quantity granularity that it wants to know, or may instruct feedback without this information. Furthermore, information about the data quantity may be included and transmitted to the IAB node. The IAB node having received this command may report a data quantity set for the DL buffer corresponding to a certain index in feedback. For contents in the BAP layer control signal, a BAP address of the parent IAB node or the DU of the parent IAP node or a BAP address of a donor node (or the DU of the donor node) may be delivered. In this case, the BAP address may be specified as an address of the egress BAP of each node or DU.

In FIG. 1S, for example, the parent IAB node instructs a flow control feedback report in a BAP signal, and accordingly, flow control feedback is performed on the BAP layer. In this case, when the parent IAB node delivers the content of the command to the IAB node, the IAB node may receive the content and deliver information declared in FIG. 1Q to the parent IAB node. Alternatively, the parent IAB node may specify and report only the information about the data quantity for a certain granularity index. Upon reception of the information, the parent IAB node schedules DL data traffic.

With the aforementioned disclosure, a cause of a failure of connection tried by a UE may be more accurately analyzed and a measure for the failure of connection tried may be more accurately taken by a BS. Furthermore, in the embodiments of the disclosure, a buffer in an IAB node may be kept at a suitable level, thereby solving a buffer overflow or underflow problem.

The disclosure is based on the NR system in which BS functions are divided into a central unit (CU) and a distributed unit (DU) where the CU is in turn divided into a CU control plane (CU-CP) and a CU user plane (CU-UP). The CU-CP supports at least a radio resource control (RRC) function, and serves to handle a control plane interface with another BS such as X2-C/Xn-C/S1-C/NG-C/F1-C, core network (CN) and the DU. The CU-UP supports at least a packet data convergent protocol (PDCP) function to process user packets, and serves to handle an interface with another BS such as X2-U/Xn-U/S1-U/NG-U/F1-U and the CN. The DU may support BS functions that are not supported by the CU, and may be connected to the CU by a control plane interface such as F1-C and a user plane interface such as F1-U. The CU-CP and the CU-UP may be connected by a control plane interface such as E1.

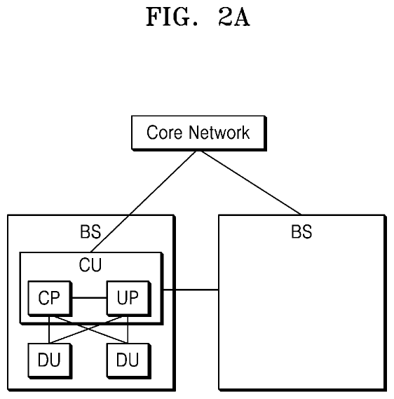

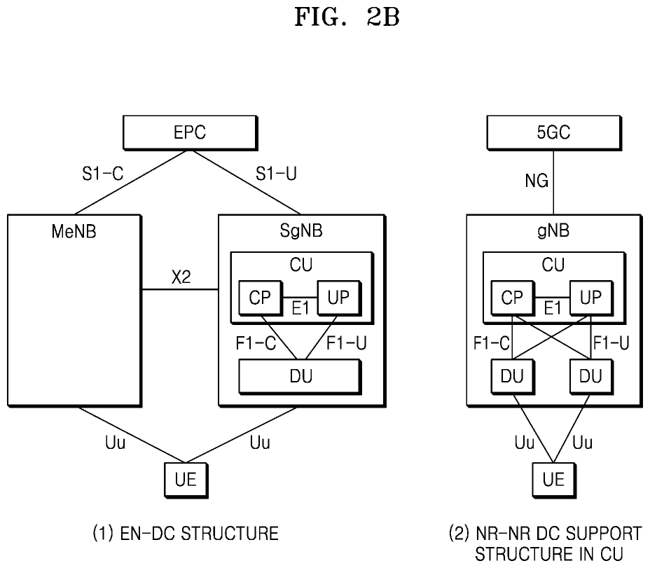

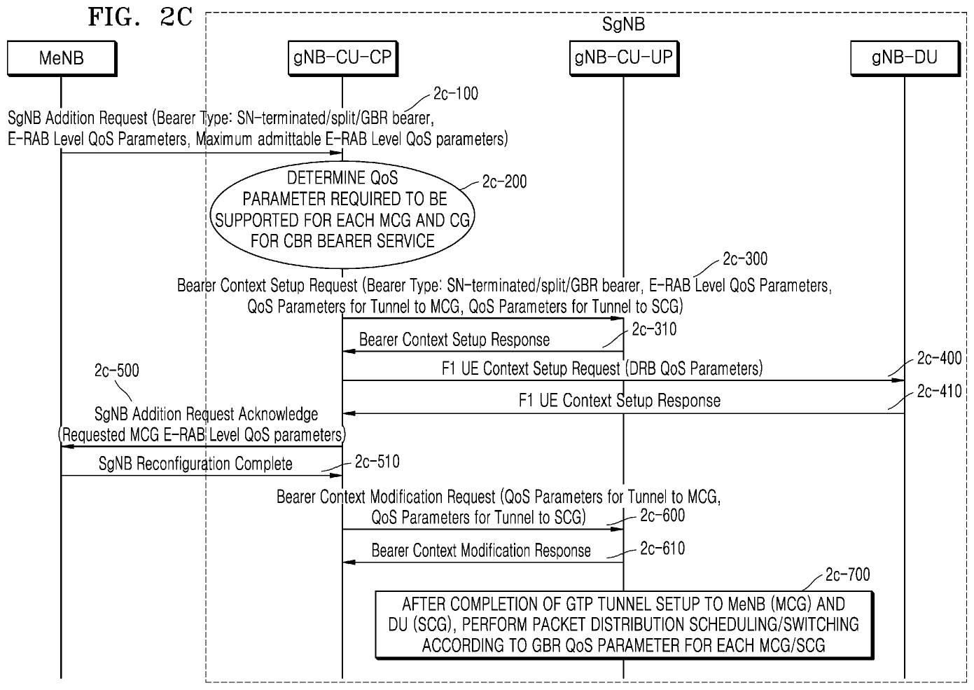

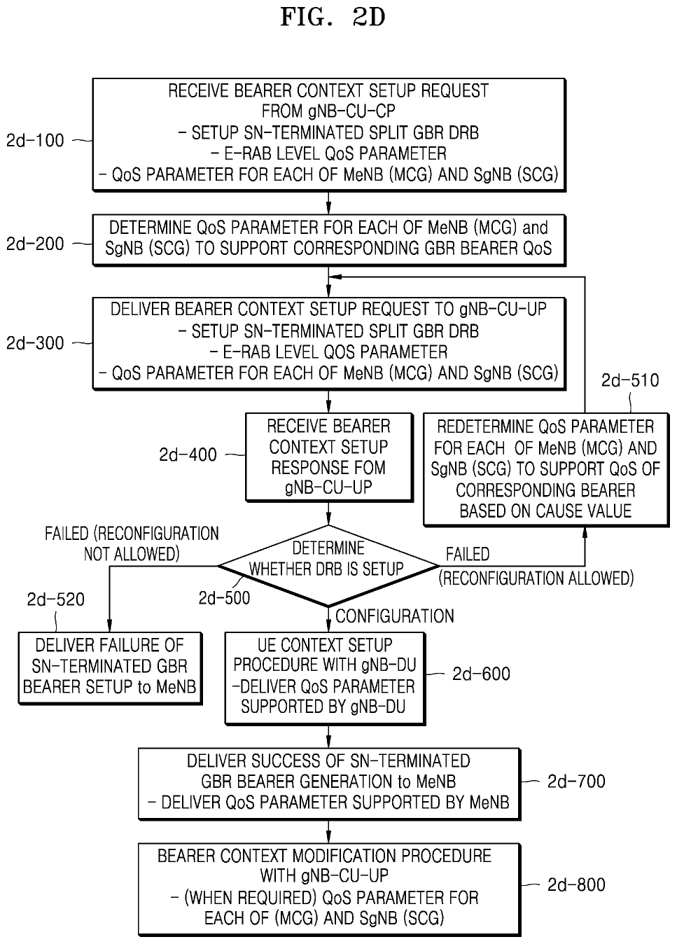

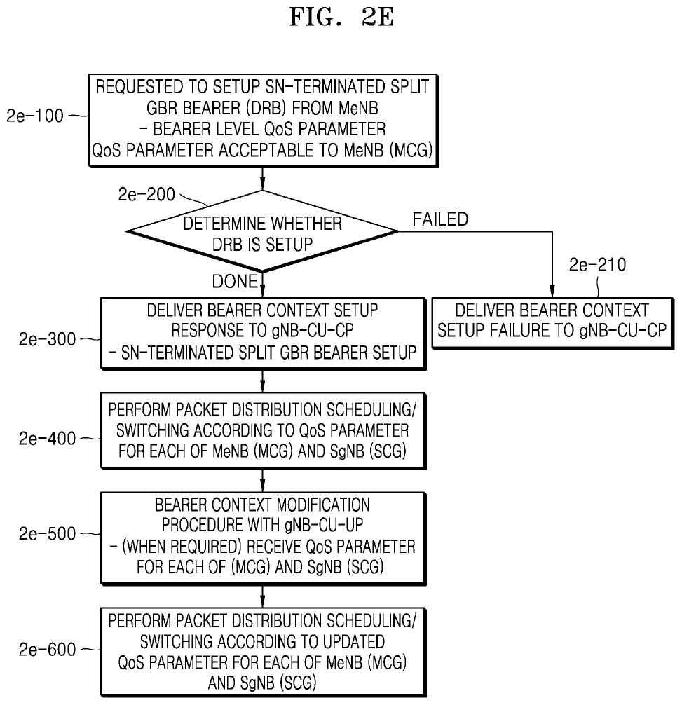

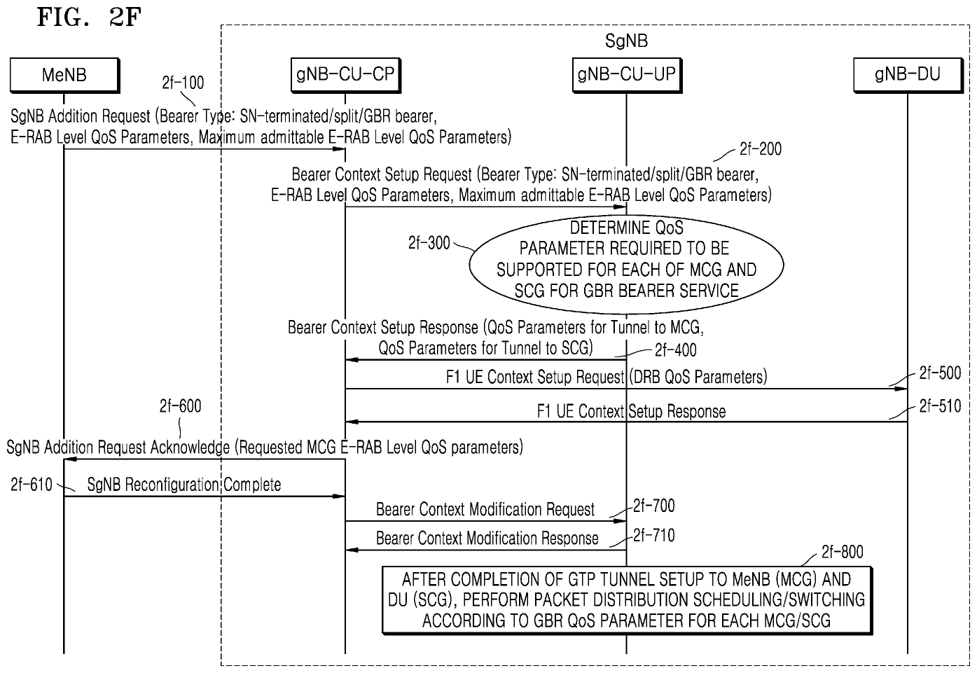

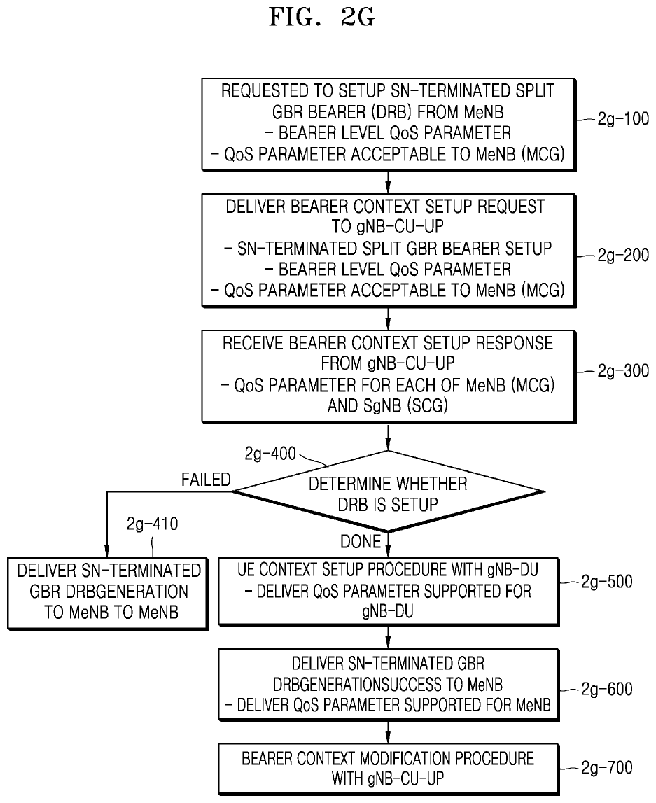

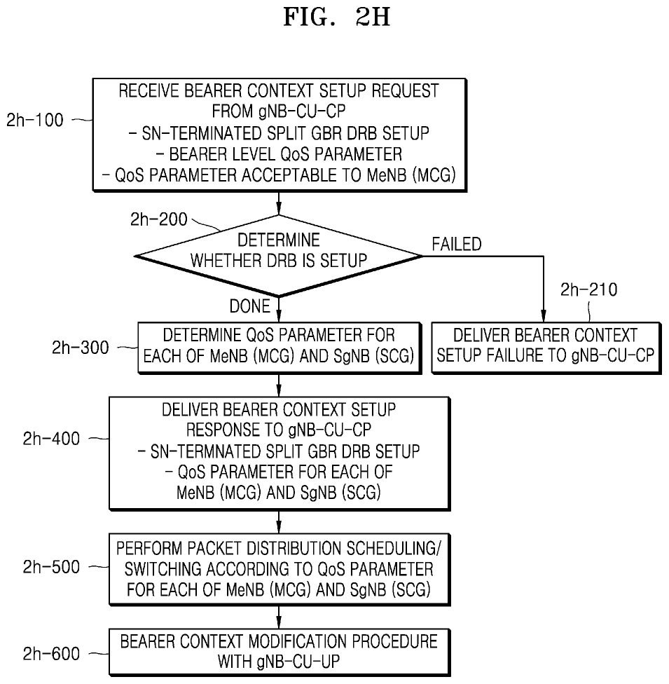

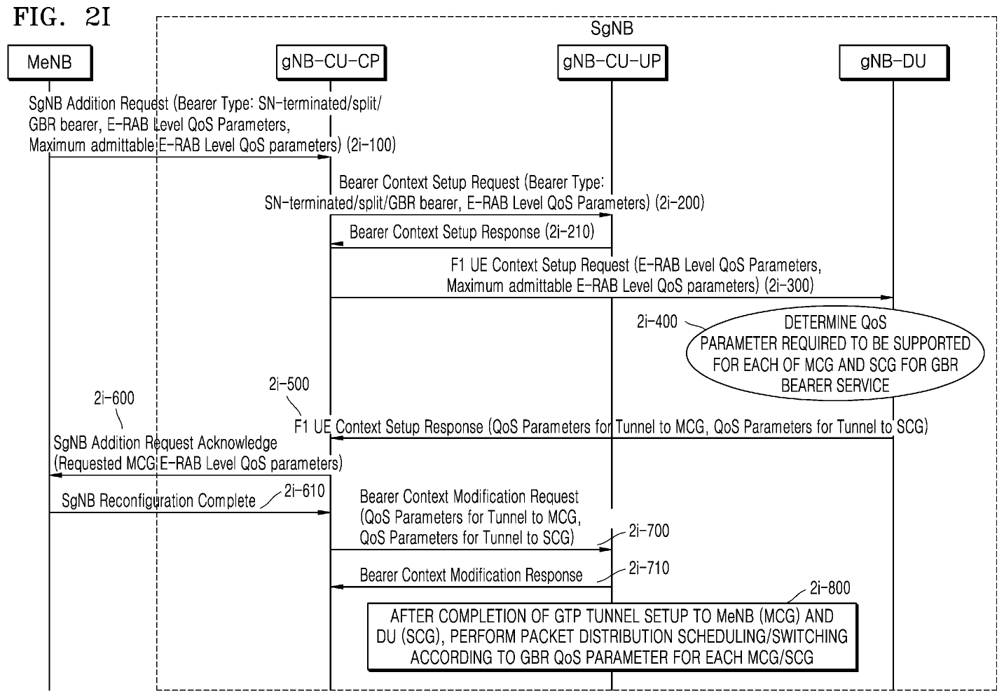

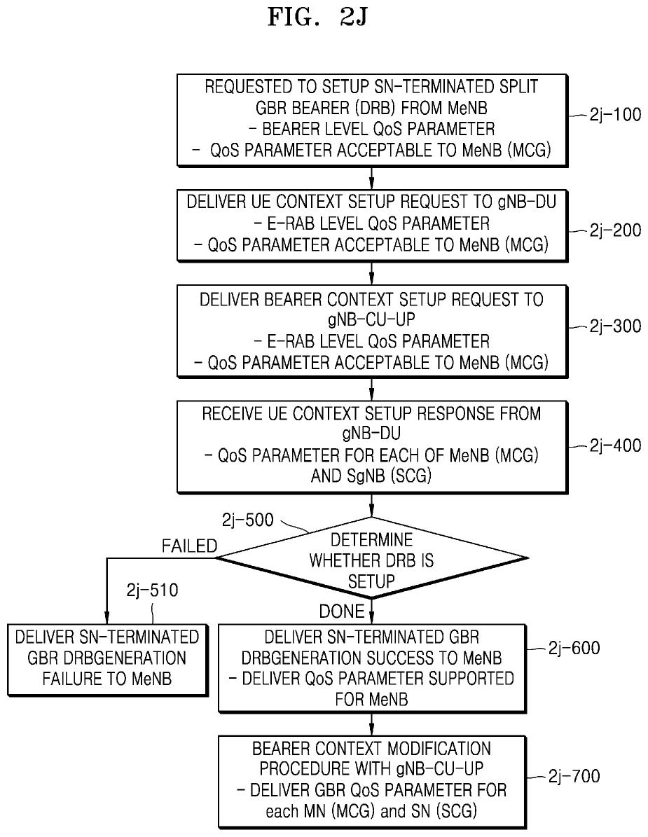

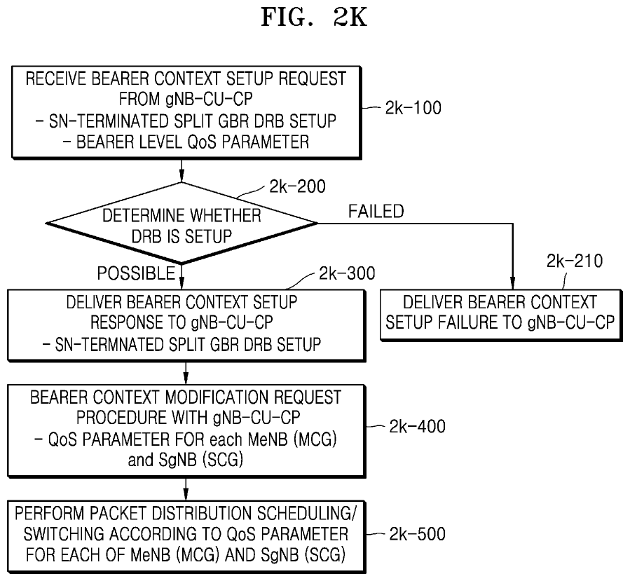

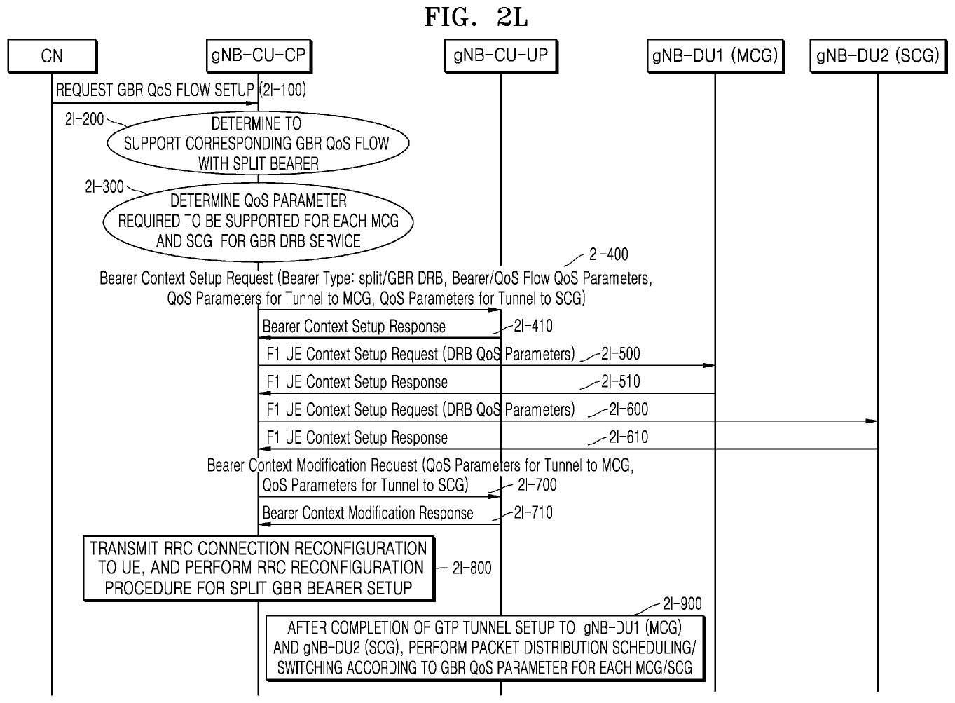

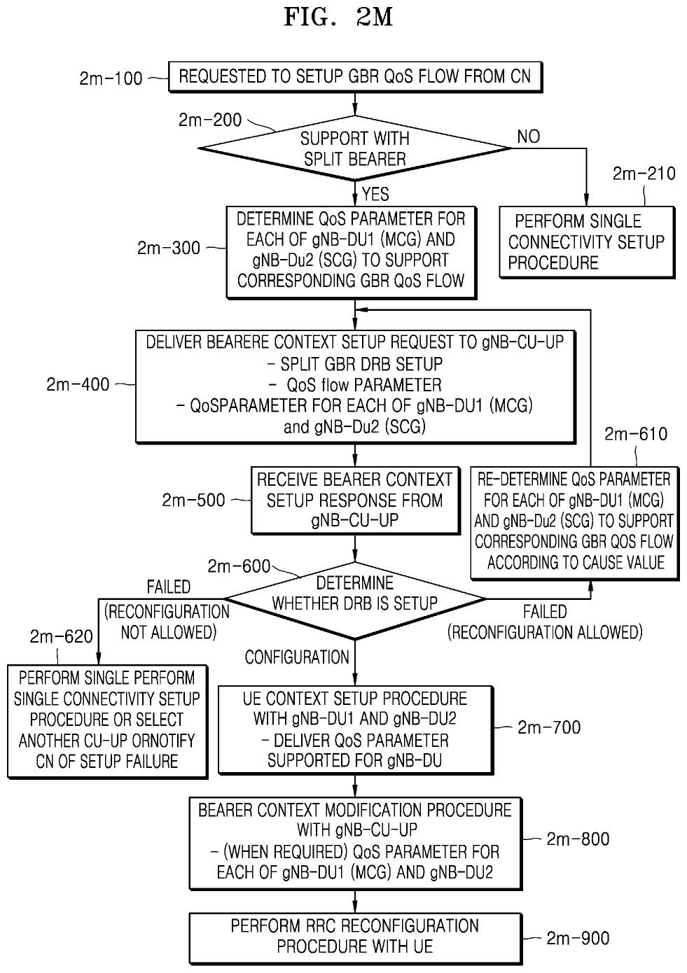

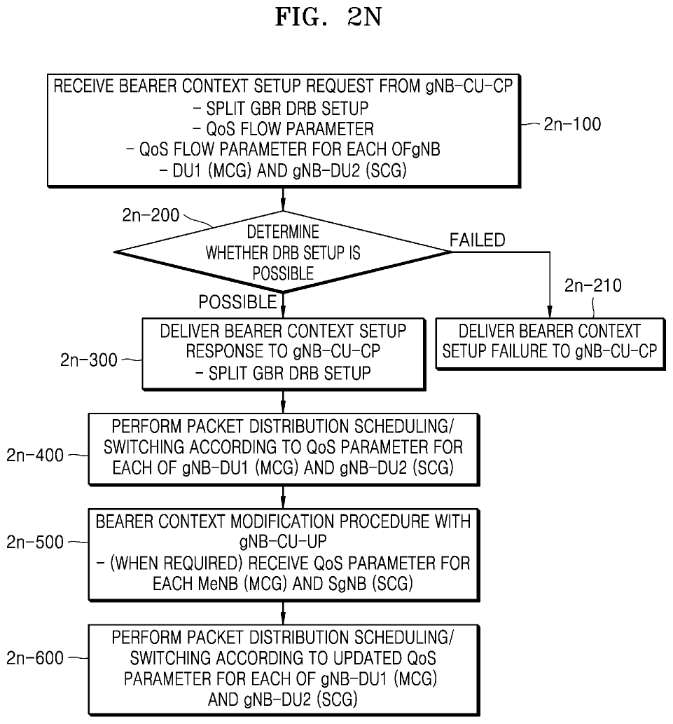

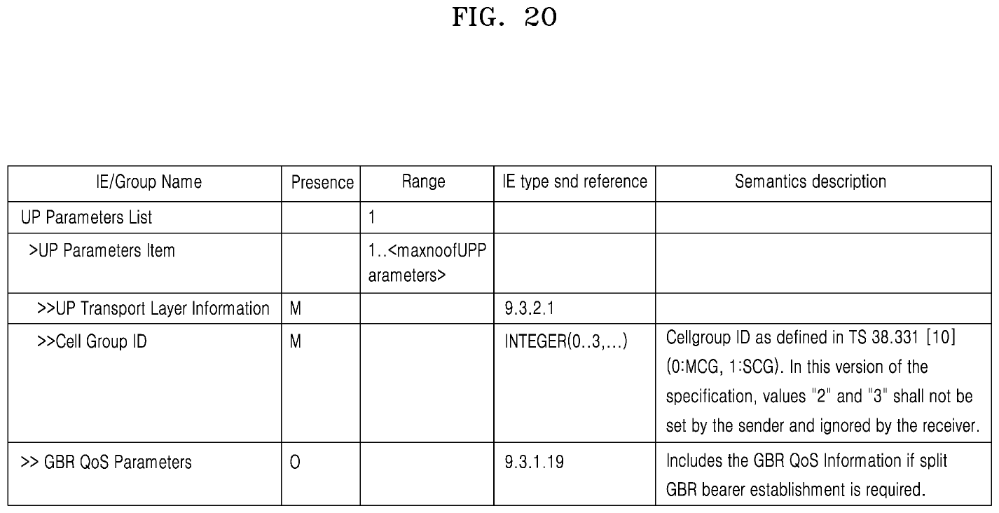

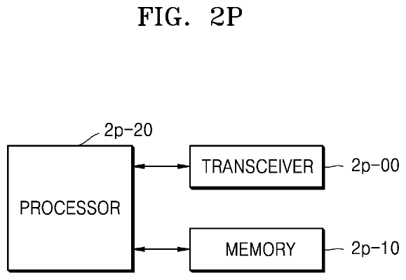

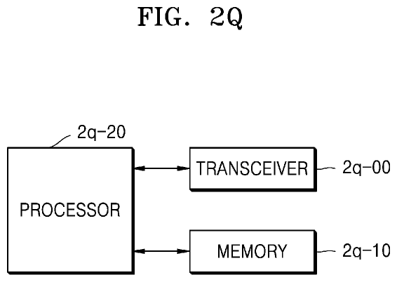

In the NR system, two or more radio links may be used to transmit packets to be transmitted through a single data radio bearer (DRB) as shown in FIG. 2B. The same radio technology or different radio technologies may be applied to the two or more radio links. In some embodiments, one radio link may use an LTE technology and the other radio link may use an NR technology to transmit packets through a single DRB. Furthermore, in some embodiments, both the two radio links may use the NR technology. (1) of FIG. 2B shows an LTE-NR dual connectivity structure as an example of a system to employ a technology proposed in the disclosure, and for an NR BS, functions of the BS may be separately configured as shown in FIG. 2A. (2) of FIG. 2B shows a structure to support NR-NR dual connectivity using one CU and two DUs as an example of another system, and for an NR BS, functions of the BS may be separately configured as shown in FIG. 2A. The technology proposed in the disclosure may be applied to different types of dual connectivity structure having a BS structure with separated functions, in addition to the dual connectivity structure included in FIG. 2B, and also applied to a case of supporting carrier aggregation with the BS structure with separated functions.

In the disclosure, in a case of providing a guaranteed bit rate (GBR) bearer service using two or more links, the BS structure with separated functions enables a PDCP anchor that distributes and delivers DL packet on two or more links to schedule or switch a packet to be distributed to each link according to GBR QoS information for each link guaranteed by the link. In embodiments of the disclosure, GBR bearer service performance may be improved by transmitting a packet while satisfying the QoS of the GBR bearer service provided on two or more links.

FIGS. 2C, 2F, and 2I show examples of a call flow when a CU-UP of a secondary gNB (SgNB) operates as a PDCP anchor and provides a GBR bearer service using both an LTE link of a master eNB (MeNB) and an NR link of the SgNB, in a case that the SgNB operates with separated functions in an EN-DC structure as shown in (1) of FIG. 2B. In FIGS. 2C, 2F, and 2I, when the CU-UP of the SgNB provides the GBR bearer service to the PDCP anchor, the CU-UP of the SgNB may adjust an amount of the DL packet to be delivered on each link by scheduling or switching based on QoS parameters provided by each of the LTE link of the MeNB and the NR link of the SgNB, to provide the GBR bearer service. In this way, the amount of packet to be delivered to the UE on each link may be increased to satisfy the QoS based on the QoS parameters supported by each link. In the GBR QoS bearer service, a packet may be discarded depending on the implementation when the packet is delivered without satisfying the QoS determined for the link.

FIG. 2C shows a call flow when a GBR QoS parameter for each link is determined by a control plane function of a node, i.e., a CU-CP of an SgNB, which provides it to a PDCP anchor, FIG. 2D is a flowchart of a process in a CU-CP of an SgNB when a CU-CP of the SgNB determines QoS parameters, and FIG. 2E is a flowchart of a process in a CU-UP of an SgNB when a CU-CP of the SgNB determines QoS parameters.

In FIG. 2C, an MeNB requests split bearer type GBR bearer service configuration from an SgNB to provide a service using both the MeNB and the SgNB with a PDCP anchor present in a CU-CP of the SgNB, in operation 2c-100. Upon reception of the request in operation 2c-100, the gNB-CU-CP determines QoS parameters to be supported by the MeNB (MCG) and the SgNB (SCG) required to provide the GBR bearer service as in operation 2c-200.

After determining QoS parameter values for each ling leg, the gNB-CU-CP operates as the PDCP anchor, and requests split GBR bearer setup while delivering QoS parameters of the bearer level and QoS parameters to be supported by each of the MeNB (MCG) and the SgNB (SCG) as in operation 2c-300, and the QoS parameter information may be delivered in conjunction with tunnel information to the MCG and the SCG.

The gNB-CU-UP receives a bearer context setup request message and proceeds internal setup, and sends a bearer context setup response to notify that the setup is completed or sends failure information when the setup is not possible, as in operation 2c-310. The gNB-CU-CP proceeds SgNB (SCG) transmission setup and delivers QoS parameter information to be supported by the gNB-DU in operations 2c-400 and 2c-410. The gNB-CU-CP sends a response of whether bearer setup requested by the MeNB is done in operations 2c-500 and 2c-510, in which case the gNB-CU-CP delivers QoS parameters required to be supported by the MeNB (MCG) for the split bearer to the MeNB.

The gNB-CU-CP requests bearer context modification from the gNB-CU-UP to complete tunnel setup for the gNB-CU-UP to deliver or receive a packet to or from the MeNB and the gNB-DU as in operations 2c-600 and 2c-610. In this case, when the gNB-CU-CP delivers no QoS parameter information supported by each of the MeNB (MCG) and the SgNB (SCG) to the gNB-CU-UP in the operation 2c-300, the gNB-CU-CP may deliver the QoS parameter information supported by each of the MeNB (MCG) and the SgNB (SCG) to the gNB-CU-UP in operation 2c-600.

The gNB-CU-UP receives the QoS parameter information supported by each of the MeNB (MCG) and the SgNB (SCG) from the gNB-CU-CP, and after completion of tunnel setup to the MeNB (MCG) and the gNB-DU (SCG), performs packet delivery scheduling or switching to each link on packets received from an evolved packet core (EPC) according to the QoS parameter information supported by the link. In some embodiments, the scheduling or switching method may use different algorithms depending on implementations, and to apply the algorithm, all or part of the QoS parameter information for each of the MCG and the SCG may be used.

FIG. 2D shows an operation flowchart of a related process in a gNB-CU-CP. In operation 2d-100, a gNB-CU-CP may receive from a MeNB a request to set up an SN-terminated split GBR bearer service for the gNB to serve as a PDCP anchor. The gNB-CU-CP uses bearer level QoS parameter information for the corresponding bearer to determine QoS parameters to be supported for each of the MeNB (MCG) and the SgNB (SCG) as in operation 2d-200. Furthermore, the gNB-CU-CP may deliver additional QoS parameter information supported for each of the MeNB (MCG) and the SgNB (SCG) along with bearer setup information and QoS parameter information of the corresponding bearer while sending a request of bearer context setup to the gNB-CU-UP as in operation 2d-300.

The gNB-CU-CP receives a response to the bearer context setup request from the gNB-CU-UP as in operation 2d-400, and determines whether the bearer (data radio bearer (DRB)) is setup based on a content included in the response message from the gNB-CU-UP and when it is failed, determines whether reconfiguration is possible as in operation 2d-500. When the reconfiguration is possible, the gNB-CU-CP re-determines QoS parameters to be supported by the MeNB (MCG) and the SgNB (SCG) as in operation 2d-510, and goes back to operation 2d-300 to proceed bearer context setup request from the gNB-CU-UP.

When the DRB setup is not possible, the gNB-CU-CP responds to the MeNB that bearer setup is failed, as in operation 2d-520. When the DRB setup is done, the gNB-CU-CP proceeds a UE context setup procedure with the gNB-DU and delivers QoS parameter information to be supported by the gNB-DU for the bearer, as in operation 2d-600. The gNB-CU-CP may notify the MeNB of completion of bearer setup as in operation 2d-700. In this case, the gN-CU-CP may deliver the QoS parameter information to be supported by the MeNB (MCG) for the bearer. The gNB-CU-CP completes bearer setup by performing a bearer context modification procedure with the gNB-CU-UP as in operation 2d-800, in which case the gNB-CU-CP may deliver QoS parameter information supported by the MeNB (MCG) and the SgNB (SCG) to the gNB-CU_UP.

FIG. 2E shows an operation flowchart of a related process in a gNB-CU-UP. The gNB-CU-UP may receive a bearer context setup request from a GNB-CU-CP as in operation 2e-100. The gNB-CU-UP determines whether DRB setup is possible based on QoS parameter information included in the request as in operation 2e-200, and when it is not possible, notifies the gNB-CU-CP that the bearer context setup is failed as in operation 2e-210.

When DRB setup is possible, the gNB-CU-UP responds to the gNB-CU-CP that bearer context setup has been proceeded while proceeding internal setup in the gNB-CU-UP for DRB support, as in operation 2e-300. Upon reception of a packet of the corresponding bearer from the core network, the gNB-CU-UP starts performing packet distribution scheduling/switching according to the QoS parameter information for each of the MeNB (MCG) and the SgNB (SCG), as in operation 2e-400. Subsequently, when required, the gNB-CU-UP may receive a bearer context modification request from the gNB-CU-CP and update internal bearer context information as in operation 2e-500, and performs packet distribution scheduling/switching according to the updated QoS parameters for each of the MeNB (NCG) and the SgNB (SCG) as in operation 2e-600.

FIG. 2F shows a call flow when a GBR QoS parameter for each link is determined by a user plane function of a node, i.e., a CU-UP of an SgNB, which provides it to a PDCP anchor, FIG. 2G is a flowchart of a process in a CU-CP of an SgNB when a CU-UP of the SgNB determines QoS parameters, and FIG. 2H is a flowchart of a process in a CU-UP of an SgNB when a CU-UP of the SgNB determines QoS parameters.

In FIG. 2F, an MeNB requests from an SgNB GBR bearer service configuration in a split bearer type that provides a service using both the MeNB and the SgNB with a PDCP anchor present in a CU-CP of the SgNB, in operation 2f-100. Upon reception of the request in the operation 2f-100, the gNB-CU-CP operates as a PDCP anchor and requests split GBR bearer setup from the gNB-CU-UP as well as delivers QoS parameter information of a bearer level received from the MeNB and maximum bearer level QoS parameter information that may be supported by the MeNB, as in operation 2f-200.

Upon reception of the request in operation 2f-200, the gNB-CU-UP determines QoS parameters to be supported by the MeNB (MCG) and the SgNB (SCG) required to provide the GBR bearer service as in operation 2f-300. Along with this, the gNB-CU-UP proceeds internal bearer setup, and then sends a bearer context setup response to notify that the setup is completed or sends failure information when the setup is not possible, as in operation 2f-400. In this case, the gNB-CU-UP delivers QoS parameters to be supported by each of the MeNB (MCG) and the SgNB (SCG) to the gNB-CU-CP, and the QoS parameter information may be delivered in conjunction with tunnel information to the MCG and SCG.

The gNB-CU-CP proceeds SgNB (SCG) transmission setup and delivers QoS parameter information to be supported by the gNB-DU in operations 2f-500 and 2f-510. The gNB-CU-CP may transmit a response of whether bearer setup requested by the MeNB is done in operations 2f-600 and 2f-610, in which case the gNB-CU-CP delivers QoS parameters required to be supported by the MeNB (MCG) for the split bearer to the MeNB.

The gNB-CU-CP requests bearer context modification from the gNB-CU-UP to complete tunnel setup for the gNB-CU-UP to deliver or receive a packet to or from the MeNB and the gNB-DU as in operations 2f-700 and 2f-710. The gNB-CU-UP receives the QoS parameter information supported by each of the MeNB (MCG) and the SgNB (SCG) from the gNB-CU-CP, and after completion of tunnel setup to the MeNB (MCG) and the gNB-DU (SCG), performs packet delivery scheduling or switching to each link on packets received from an EPC according to the QoS parameter information supported by the link, as in operation 2f-800.

In some embodiments, the scheduling or switching method may use different algorithms depending on implementations, and to apply the algorithm, all or part of the QoS parameter information for each of the MCG and the SCG may be used.

FIG. 2G shows an operation flowchart of a related process in a gNB-CU-CP. In operation 2g-100, a gNB-CU-CP may receive from a MeNB a request to set up an SN-terminated split GBR bearer service for the gNB to serve as a PDCP anchor. The gNB-CU-CP delivers bearer setup information and QoS parameter information of the bearer while requesting bearer context setup from the gNB-CU-UP as in operation 2g-200. The gNB-CU-CP receives QoS parameters to be supported for each of the MeNB (MCG) and the SgNB (SCG) while receiving a response to the bearer context setup request from the gNB-CU-UP as in operation 2g-300. Furthermore, the gNB-CU-CP may determine whether a bearer (data radio bearer (DRB)) has been setup based on contents included in the response message from the gNB-CU-UP as in operation 2g-400.

When the DRB setup is failed, the gNB-CU-CP responds to the MeNB that bearer setup is failed, as in operation 2g-410. When the DRB setup is done, the gNB-CU-CP proceeds a UE context setup procedure with the gNB-DU and delivers QoS parameter information to be supported by the gNB-DU for the bearer, as in operation 2g-500. The gNB-CU-CP notifies the MeNB of completion of bearer setup as in operation 2d-600, in which case QoS parameter information to be supported by the MeNB (MCG) for the bearer is delivered. Furthermore, the gNB-CU-CP completes bearer setup by performing the bearer context modification procedure with the gNB-CU-UP as in operation 2g-700.

FIG. 2H shows an operation flowchart of a related process in a gNB-CU-UP. When receiving the bearer context setup request from the gNB-CU-CP in operation 2h-100, the gNB-CU-UP may determine whether DRB setup is possible based on the QoS parameter information included in the request as in operation 2h-200.

When it is not possible, the gNB-CU-UP notifies the gNB-CU-CP that the bearer context setup is failed as in operation 2h-210. When the DRB setup is possible, the gNB-CU-UP uses bearer level QoS parameter information for the corresponding bearer to determine QoS parameters to be supported for each of the MeNB (MCG) and the SgNB (SCG) as in operation 2f-300 while proceeding internal setup in the gNB-CU-UP for DRB support. The gNB-CU-UP delivers QoS parameters to be supported for each of the MeNB (MCG) and the SgNB (SCG) to the gNB-CU-CP while sending a response to the gNB-CU-CP that the bearer context setup has been proceeded, as in operation 2h-400.

Upon reception of a packet of the corresponding bearer from the core network, the gNB-CU-UP starts performing packet distribution scheduling/switching according to the QoS parameter information for each of the MeNB (MCG) and the SgNB (SCG), as in operation 2h-500. After this, when required, the gNB-CU-UP may update the internal bearer context information upon reception of a bearer context modification request from the gNB-CU-CP, as in operation 2h-600.

FIG. 2I shows a call flow when a GBR QoS parameter for each link is determined by a function of a node responsible for transmission and reception between the node and the UE, i.e., a DU of an SgNB, which provides it to a PDCP anchor, FIG. 2J is a flowchart of a process in a CU-CP in a SgNB when a DU of the SgNB determines QoS parameters, and FIG. 2H is a flowchart of a process in a CU-UP of an SgNB when a DU of the SgNB determines QoS parameters.

In FIG. 2I, an MeNB requests split bearer type GBR bearer service configuration from an SgNB to provide a service using both the MeNB and the SgNB with a PDCP anchor present in a CU-CP of the SgNB, in operation 2i-100. Upon reception of the request in the operation 2i-100, the gNB-CU-CP operates as a PDCP anchor and requests split GBR bearer setup from the gNB-CU-UP as well as delivers QoS parameters of a bearer level as in operation 2i-200.

The gNB-CU-UP receives the bearer context setup request message and proceeds internal setup, and sends a bearer context setup response to notify that the setup is completed or sends failure information when the setup is not possible, as in operation 2i-210. The gNB-CU-CP requests a UE context setup from the SgNB (SCG), and delivers QoS parameter information of a bearer level received from the MeNB and maximum bearer level QoS parameter information that may be supported by the MeNB in the request, as in operation 2i-300.

The gNB-DU determines QoS parameters to be supported by the MeNB (MCG) and the SgNB (SCG) required to provide the GBR bearer service as in operation 2i-400. Along with this, the gNB-DU proceeds internal UE context setup and notifies the gNB-CU-CP that the UE context setup has been completed as in operation 2i-500 while delivering the QoS parameters to be supported by each of the MeNB (MCG) and the SgNB (SCG).

The gNB-CU-CP sends a response of whether bearer setup requested by the MeNB is done in operations 2i-600 and 2i-610, in which case the gNB-CU-CP delivers QoS parameters required to be supported by the MeNB (MCG) for the split bearer to the MeNB. The gNB-CU-CP requests bearer context modification from the gNB-CU-UP to complete tunnel setup for the gNB-CU-UP to deliver or receive a packet to or from the MeNB and the gNB-DU as in operations 2i-700 and 2i-710.

In this case, the gNB-CU-CP may deliver QoS parameter information supported by each of the MeNB (MCG) and the SgNB (SCG) to the gNB-CU-UP. The gNB-CU-UP receives the QoS parameter information supported by each of the MeNB (MCG) and the SgNB (SCG) from the gNB-CU-CP, and after completion of tunnel setup to the MeNB (MCG) and the gNB-DU (SCG), performs packet delivery scheduling or switching to each link on packets received from an EPC according to the QoS parameter information supported by the link, as in operation 2i-800.

In some embodiments, the scheduling or switching method may use different algorithms depending on implementations, and to apply the algorithm, all or part of the QoS parameter information for each of the MCG and the SCG may be used.

FIG. 2J shows an operation flowchart of a related process in a gNB-CU-CP. In operation 2j-100, a gNB-CU-CP may receive from a MeNB a request to set up an SN-terminated split GBR bearer service for the gNB to serve as a PDCP anchor. The gNB-CU-CP delivers bearer setup information and QoS parameter information of the bearer while requesting bearer context setup from the gNB-CU-UP as in operation 2J-200. The gNB-CU-CP also requests UE context setup as in operation 2j-300, in which case the gNB-CU-CP delivers bearer level QoS parameter information for the bearer received from the MeNB and QoS parameter information that may be accepted by the MeNB (MCG) to the gNB-DU.

The gNB-CU-CP receives a UE context setup response from the gNB-DU as in operation 2j-400 along with QoS parameter information for each of the MeNB (MCG) and the SgNB (SCG). The gNB-CU-CP determines whether the bearer (data radio bearer (DRB)) is setup based on a content included in the response message from the gNB-CU-UP or the gNB-DU in operation 2j-500, and when the DRB setup is failed, sends a response to the MeNB that the bearer setup is failed as in operation 2j-510.

When the DRB is setup, the gNB-CU-CP notifies the MeNB of completion of the bearer setup as in operation 2j-600, in which case QoS parameter information to be supported by the MeNB (MCG) for the bearer is delivered. The gNB-CU-CP completes bearer setup by performing a bearer context modification procedure with the gNB-CU-UP as in operation 2j-700, in which case the gNB-CU-CP may deliver QoS parameter information to be supported by each of the MeNB (MCG) and the SgNB (SCG) to the gNB-CU-UP.

FIG. 2K shows an operation flowchart of a related process in a gNB-CU-UP. The gNB-CU-UP receives a bearer context setup request from a gNB-CU-CP as in operation 2k-100. The gNB-CU-UP determines whether DRB setup is possible based on QoS parameter information included in the request as in operation 2k-200, and when it is not possible, notifies the gNB-CU-CP that the bearer context setup is failed as in operation 2k-210. When DRB setup is possible, the gNB-CU-UP notifies the gNB-CU-CP that the bearer setup has been completed while proceeding internal setup in the gNB-CU-UP for DRB support, as in operation 2k-300.

When the gNB-CU-UP completes bearer setup through a bearer context modification procedure and receives the QoS parameter information to be supported for each of the MeNB (MCG) and the SgNB (SCG) from the gNB-CU-UP as in operation 2k-400, the gNB-CU-UP updates a context of the bearer stored in a gNB-CU-UP sop and, upon reception of a packet of the bearer from a core network, performs packet distribution scheduling/switching based on the QoS parameter information for each of the MeNB (MCG) and the SgNB (SCG) as in operation 2k-500.

FIG. 2I shows an example of a call flow when a gNB that operates with separated functions as in (2) of FIG. 2B provides a GBR bearer service on two NR links at a time using two DUs in a CU of the gNB. In FIG. 2I, when a CU-UP of a gNB provides a GBR bearer service to the PDCP anchor, the CU-UP of the gNB may adjust an amount of the DL packet to be delivered on each link by scheduling or switching according to QoS parameters of each link of the CU-UP of the SgNB based on QoS parameters provided by each NR link (gNB-DU1 and gNB-DU2) from the CU-CP of the gNB, to provide the GBR bearer service. In this way, the amount of packet to be delivered to the UE on each link may be increased and the QoS on each link may be satisfied based on the GBR QoS parameters. In the GBR QoS bearer service, a packet may be discarded depending on the implementation when the packet is delivered without satisfying the QoS determined for the link.

FIG. 2L shows a call flow when a GBR QoS parameter for each link is determined by a control plane function of a node, i.e., a CU-CP of the gNB, which provides it to a PDCP anchor, FIG. 2M is a flowchart of a process in a CU-CP of a gNB when the CU-CP of the gNB determines QoS parameters, and FIG. 2N is a flowchart of a process in a CU-UP of a gNB when a CU-CP of the gNB determines QoS parameters.

Technologies proposed in the disclosure may be equally applied to a case of using carrier aggregation (CA) that supports multiple links using only one gNB-DU, which may be operated in the format of a call flow with only one gNB-DU. In this case, the CU-UP performs packet scheduling/switching to be distributed to a tunnel to each link according to the QoS parameter information provided on each radio link for CA for the bearer service, which may be similar to a case of dual connectivity operation in the gNB-CU-UP.

Furthermore, in a case of providing the GBR bearer service on two NR links simultaneously using two DUs in the CU of the gNB, the gNB-CU-UP or the gNB-DU may determine QoS parameters to be supported for each radio link for the bearer service in a similar manner as in the split GBR bearer support case in the aforementioned EN-DC, and the gNB-CU-UP may use the information for packet distribution scheduling/switching.

In FIG. 2L, the gNB-CU-CP receives a request for GBR QoS flow setup from a core network (CN) in operation 2l-100, determines whether to support the gBR QoS flow with a split bearer as in operation 2l-200, and when the gBR QoS flow is supported with the split bearer, determines QoS parameter values for each link leg using QoS flow information received from the CN, as in operation 2l-300.

After this, as in operation 2l-400, the gNB-CU-CP operates as a PDCP anchor, and requests split GBR bearer setup while delivering QoS parameters of a QoS flow level and QoS parameters to be supported by each of a gNB-DU1 (MCG) and a gNB-DU2 (SCG), and the QoS parameter information may be delivered in conjunction with tunnel information to the MCG and the SCG.

The gNB-CU-UP receives the bearer context setup request message and proceeds internal setup, and sends a bearer context setup response to notify that the setup is completed or sends failure information when the setup is not possible, as in operation 2l-410. The gNB-CU-CP proceeds UE context setup for transmission to the gNB-DU1 (MCG) and the gNB-DU2 (SCG) and delivers QoS parameters to be supported by each of the gNB-DU1 (MCG) and the gNB-DU2 (SCG), as in operations 2l-500, 2l-510, 2l-600, and 2l-610. After this, the gNB-CU-CP requests bearer context modification from the gNB-CU-UP to complete tunnel setup for gNB-CU-UP to deliver or receive a packet to or from the gNB-DU1 (MCG) and the gNB-DU2 (SCG) as in operations 2l-700 and 2l-710. In this case, when the gNB-CU-CP delivers no QoS parameter information supported by each of the gNB-DU1 (MCG) and the gNB-DU2 (SCG) to the gNB-CU-UP in the operation 2l-400, the gNB-CU-CP may deliver the QoS parameter information supported by each of the gNB-DU1 (MCG) and the gNB-DU2 (SCG) to the gNB-CU-UP in operation 2l-700.

The gNB-CU-CP proceeds radio setup for a split GBR bearer service by transmitting an RRC reconfiguration message to the UE as in operation 2l-800. The gNB-CU-UP receives the QoS parameter information supported by each of the gNB-DU1 (MCG) and the gNB-DU2 (SCG) from the gNB-CU-CP, and after completion of tunnel setup to the gNB-DU1 (MCG) and the gNB-DU2 (SCG), performs packet delivery scheduling or switching to each link on packets received from the CN according to the QoS parameter information supported by each radio link, as in operation 2l-900.

In some embodiments, the scheduling or switching method may use different algorithms depending on implementations, and to apply the algorithm, all or part of the QoS parameter information for each of the MCG and the SCG may be used.

FIG. 2M shows an operation flowchart of a related process in a gNB-CU-CP. When a gNB-CU-CP receives a GBR QoS flow setup request from a core network (CN) in operation 2m-100, the gNB-CU-CP determines whether to support a corresponding QoS flow with a split bearer as in operation 2m-200.

When it is not supported with the split bearer, the gNB-CU-CP performs a single connectivity setup procedure as in operation 2m-210, which is out of the scope of what is proposed in the disclosure. In a case of supporting the GBR QoS flow service with the split bearer, the gNB-CU-CP determines QoS parameters to be supported for each of the gNB-DU1 (MCG) and the gNB-DU2 (SCG) using e.g., the QoS flow level QoS parameter information as in operation 2m-300.

The gNB-CU-CP delivers additional QoS parameter information supported for each of the gNB-DU1 (MCG) and the gNB-DU2 (SCG) along with bearer setup information and QoS parameter information of the corresponding bearer and QoS flow while sending a bearer context setup request to the gNB-CU-UP as in operation 2m-400. The gNB-CU-CP receives a response to the bearer context setup request from the gNB-CU-UP as in operation 2m-500, and determines whether the bearer (data radio bearer (DRB)) is setup based on a content included in the response message from the gNB-CU-UP and when it is failed, determines whether reconfiguration is possible as in operation 2m-600.

When the reconfiguration is possible, the gNB-CU-CP re-determines QoS parameters to be supported by the gNB-DU1 (MCG) and the gNB-DU2 (SCG) as in operation 2m-610, and goes back to operation 2m-400 to proceed bearer context setup request from the gNB-CU-UP. When the DRB setup is not possible, the gNB-CU-CP provides the QoS flow service with single connectivity as in operation 2m-620, or begins with the operation 2m-300 by selecting another gNB-CU-UP, or notifies a failure of the QoS flow service setup.

When the DRB setup is done, the gNB-CU-CP proceeds a UE context setup procedure with the gNB-DU1 (MCG) and the gNB-DU2 (SCG) and delivers QoS parameter information to be supported by each gNB-DU for the bearer, as in operation 2m-700. The gNB-CU-CP completes bearer setup by performing a bearer context modification procedure with the gNB-CU-UP as in operation 2m-800, in which case the gNB-CU-CP may deliver QoS parameter information supported by the gNB-DU1 (MCG) and the gNB-DU2 (SCG) to the gNB-CU_UP. The gNB-CU-CP then performs an RRC reconfiguration procedure with the UE as in operation 2m-900.

FIG. 2N shows an operation flowchart of a related process in a gNB-CU-UP. When receiving the bearer context setup request from the gNB-CU-CP in operation 2n-100, the gNB-CU-UP determines whether DRB setup is possible based on the QoS parameter information included in the request as in operation 2n-200.

When it is not possible, the gNB-CU-UP notifies the gNB-CU-CP that the bearer context setup is failed as in operation 2n-210. When DRB setup is possible, the gNB-CU-UP responds to the gNB-CU-CP that bearer context setup has been proceeded while proceeding internal setup in the gNB-CU-UP for DRB support, as in operation 2n-300.

Upon reception of a packet of the corresponding bearer from a core network, the gNB-CU-UP starts performing packet distribution scheduling/switching according to the QoS parameter information for each of the gNB-DU1 (MCG) and the gNB-DU2 (SCG), as in operation 2n-400. Subsequently, when required, the gNB-CU-UP may receive a bearer context modification request from the gNB-CU-CP and update internal bearer context information as in operation 2n-500, and then performs packet distribution scheduling/switching according to the updated QoS parameters for each of the gNB-DU1 (MCG) and the gNB-DU2 (SCG) as in operation 2n-600.

FIG. 2O shows an example of an information element configuration required to deliver QoS parameter information to be supported for each link leg (e.g., for each of MCG and SCG) in a message delivered to a CU-UP from a CU-CP or to the CU-CP from the CU-UP of an SgNB or gNB. The QoS parameter information supported on each radio link may be delivered for each transport tunnel of a user plane (UP) to deliver a packet to MCG and SCG entities. It is not limited thereto. For example, unlike the aforementioned method, the QoS parameters may be designated and delivered for each of the MCG and SCG entities, and the message configuration to deliver information may be made in various methods.

FIG. 2P is a block diagram illustrating a structure of a UE, according to some embodiments of the disclosure. As shown in FIG. 2P, the UE may include a processor 2p-20, a transceiver 2p-00, and a memory 2p-10. Components of the UE are not, however, limited thereto. For example, the UE may include more or fewer elements than described above. In addition, the processor 2p-20, the transceiver 2p-00, and the memory 2p-10 may be implemented in a single chip. The UE in FIG. 2P may correspond to aforementioned UE.

In some embodiments, the processor 2p-20 may control a series of processes for the UE to be operated according to the embodiments of the disclosure.

The transceiver 2p-00 may transmit or receive signals to or from a BS. The signals to be transmitted to or received from the BS may include control information and data. The transceiver 2p-00 may include an RF transmitter for up-converting the frequency of a signal to be transmitted and amplifying the signal and an RF receiver for low-noise amplifying a received signal and down-converting the frequency of the received signal. It is merely an example, and the elements of the transceiver 2p-00 are not limited to the RF transmitter and RF receiver. In addition, the transceiver 2p-00 may receive a signal on a wireless channel and output the signal to the processor 2p-20, or transmit a signal output from the processor 2p-20 on a wireless channel.

In some embodiments of the disclosure, the memory 2p-10 may store a program and data required for operation of the UE. Furthermore, the memory 2p-10 may store control information or data included in a signal transmitted or received by the UE. The memory 2p-10 may include a storage medium such as a ROM, a RAM, a hard disk, a CD-ROM, and a DVD, or a combination of storage mediums. Moreover, the memory 2p-10 may be in the plural. In some embodiments, the memory 2p-10 may store a program to perform the aforementioned embodiments of the disclosure.

FIG. 2Q is a block diagram illustrating a structure of a BS, according to some embodiments of the disclosure. As shown in FIG. 2Q, the BS may include a processor 2q-20, a transceiver 2q-00, and a memory 2q-10. Components of the BS are not, however, limited thereto. For example, the BS may include more or fewer elements than described above. In addition, the processor 2q-20, the transceiver 2q-00, and the memory 2q-10 may be implemented in a single chip. The BS in FIG. 2Q may correspond to aforementioned BS.

The processor 2q-20 may control a series of processes for the BS to be operated according to the embodiments of the disclosure.

The transceiver 2q-00 may transmit or receive signals to or from a UE. The signals to be transmitted to or received from the UE may include control information and data. The transceiver 2q-00 may include an RF transmitter for up-converting the frequency of a signal to be transmitted and amplifying the signal and an RF receiver for low-noise amplifying a received signal and down-converting the frequency of the received signal. It is merely an example, and the elements of the transceiver 2q-00 are not limited to the RF transmitter and RF receiver. In addition, the transceiver 2q-00 may receive a signal on a wireless channel and output the signal to the processor 2q-20, or transmit a signal output from the processor 2q-20 on a wireless channel. The processor 2q-20 may be in the plural.

In some embodiments of the disclosure, the memory 2q-10 may store a program and data required for operation of the BS. Furthermore, the memory 2q-10 may store control information or data included in a signal transmitted or received by the BS. The memory 2q-10 may include a storage medium such as a ROM, a RAM, a hard disk, a CD-ROM, and a DVD, or a combination of storage mediums. Moreover, the memory 2q-10 may be in the plural. In some embodiments, the memory 2q-10 may store a program to perform the aforementioned embodiments of the disclosure.

Methods according to the claims of the disclosure or the embodiments described in the specification may be implemented in hardware, software, or a combination of hardware and software.

When implemented in software, a computer-readable storage medium storing one or more programs (software modules) may be provided. The one or more programs stored in the computer-readable storage medium are configured for execution by one or more processors in an electronic device. The one or more programs may include instructions that cause the electronic device to perform the methods in accordance with the claims of the disclosure or the embodiments described in the specification.

The programs (software modules, software) may be stored in a RAM, a non-volatile memory including a flash memory, a ROM, an electrically erasable programmable ROM (EEPROM), a magnetic disc storage device, a CD-ROM, a DVD or other types of optical storage device, and/or a magnetic cassette. Alternatively, the programs may be stored in a memory including a combination of some or all of them. Each of the memories may be provided in the plural.

The program may also be stored in an attachable storage device that may be accessed over a communication network including the Internet, an intranet, a LAN, a wide LAN (WLAN), or a storage area network (SAN), or a combination thereof. The storage device may be connected to an apparatus performing the embodiments of the disclosure through an external port. Furthermore, an extra storage device in the communication network may access a device that performs the embodiments of the disclosure.

In the embodiments of the disclosure, a component is represented in a singular or plural form. It should be understood, however, that the singular or plural representations are selected appropriately according to the situations presented for convenience of explanation, and the disclosure is not limited to the singular or plural form of the component. Further, the component expressed in the plural form may also imply the singular form, and vice versa.

Several embodiments of the disclosure have been described, but a person of ordinary skill in the art will understand and appreciate that various modifications can be made without departing the scope of the disclosure. Thus, it will be apparent to those of ordinary skill in the art that the disclosure is not limited to the embodiments of the disclosure described, which have been provided only for illustrative purposes. Furthermore, the embodiments may be operated by being combined with one another 1f necessary. For example, an embodiment of the disclosure and some of another embodiment of the disclosure may be combined to operate the BS and the UE. The embodiments of the disclosure may be equally applied to other communication systems, and other modifications of the embodiments may also be made without departing from the scope of the disclosure.

1.-15. (canceled)

16. A first integrated access backhaul (IAB) node, the first IAB node comprising:
a transceiver; and
at least one processor configured to:
identify a buffer load of the first IAB node or at least one command received from a second IAB node, via a backhaul adaptation protocol (BAP) layer, and
in case that the buffer load exceeds a specified level or a command for requesting a BAP flow control feedback is received, transmit, via the transceiver, a BAP flow control feedback to the second IAB node.

17. The first IAB node of claim 16, wherein the BAP flow control feedback includes information regarding an available buffer size.

18. The first IAB node of claim 16, wherein the BAP flow control feedback includes a backhaul radio link control (BH RLC) channel identifier (ID).

19. The first IAB node of claim 16, wherein the at least one processor is further configured to:
receive, via the transceiver, configuration information from the second IAB node, and
identify the specified level based on the configuration information.

20. A second integrated access backhaul (IAB) node, the second IAB node comprising:
a transceiver; and
at least one processor configured to:
transmit, via the transceiver, a command for requesting a backhaul adaptation protocol (BAP) flow control feedback to a first IAB node, via a BAP layer, and
receive, via the transceiver, a BAP flow control feedback from the first IAB node based on the transmitted command.

21. The second IAB node of claim 20, wherein the BAP flow control feedback includes information regarding an available buffer size.

22. The second IAB node of claim 20, wherein the BAP flow control feedback includes a backhaul radio link control (BH RLC) channel identifier (ID).

23. The second IAB node of claim 20, wherein in case that a buffer load of the first IAB node exceeds a specified level, the BAP flow control feedback is transmitted, from the first IAB node to the second IAB node.

24. The second IAB node of claim 23, wherein the at least one processor is further configured to:
transmit, via the transceiver, configuration information including information regarding the specified level, to the first IAB node.

25. A method performed by a first integrated access backhaul (IAB) node, the method comprising:
identifying a buffer load of the first IAB node or at least one command received from a second IAB node, via a backhaul adaptation protocol (BAP) layer; and
in case that the buffer load exceeds a specified level or a command for requesting a BAP flow control feedback is received, transmitting a BAP flow control feedback to the second IAB node.

26. The method of claim 25, wherein the BAP flow control feedback includes information regarding an available buffer size.

27. The method of claim 25, wherein the BAP flow control feedback includes a backhaul radio link control (BH RLC) channel identifier (ID).

28. The method of claim 25, further comprising:
receiving configuration information from the second IAB node; and
identifying the specified level based on the configuration information.

29. A method performed by a second integrated access backhaul (IAB) node, the method comprising:
transmitting a command for requesting a backhaul adaptation protocol (BAP) flow control feedback to a first IAB node, via a BAP layer; and
receiving a BAP flow control feedback from the first IAB node based on the transmitted command.

30. The method of claim 29, wherein the BAP flow control feedback includes information regarding an available buffer size.

31. The method of claim 29, wherein the BAP flow control feedback includes a backhaul radio link control (BH RLC) channel identifier (ID).

32. The method of claim 29, wherein in case that a buffer load of the first IAB node exceeds a specified level, the BAP flow control feedback is transmitted, from the first IAB node to the second IAB node.

33. The method of claim 32, further comprising:
transmitting configuration information including information regarding the specified level, to the first IAB node.
